(19) United States
(12) Patent Application Publication
(10) Pub. No.: US 2008/0093006 A1
(43) Pub. Date: Apr. 24, 2008

(54) Fuel cell devices, systems, and methods

(76) Inventors: David Dillard, Blacksburg, VA (US); Michael Ellis, Blacksburg, VA (US); Shu Guo, Pearland, TX (US); Kenneth Reed Henderson JR., Herndon, VA (US); Joshua D. Sole, Sarasota, FL (US)

Correspondence Address: MICHAEL N. HAYNES, 1341 HUNTERSFIELD CLOSE, KESWICK, VA, 22947, US

(21) Appl. No.: 11/641,136

(22) Filed: Dec. 19, 2006

Related U.S. Application Data
(60) Provisional application No. 60/751,734, filed on Dec. 19, 2005.

(51) Int. Cl. B29C 65/00

(52) U.S. Cl. 156/60

(57) ABSTRACT

Certain exemplary embodiments comprise devices, systems and methods associated with making and/or using a fabric. The fabric can comprise a hydrophobic coating. The fabric can comprise a microporous sub-layer. Certain exemplary embodiments comprise fuel cells and/or fuel cell structures adapted to utilize the fabric for one or more gas permeable electrically conductive layers.

### CROSS-REFERENCES TO RELATED APPLICATIONS

This application claims priority to, and incorporates by reference herein in their entirety, the following pending patent applications:
U.S. 60/636,868, filed 19 Dec. 2005.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a graph showing results for resistance tests of certain exemplary embodiments;

FIG. 2 is a graph showing results for current density tests of certain exemplary embodiments;

FIG. 3 is a block diagram of an exemplary embodiment of a system 3000;

FIG. 4 is a block diagram of an exemplary embodiment of a system 4000;

FIG. 5 is a block diagram of an exemplary embodiment of a system 5000;

FIG. 6 is a block diagram of an exemplary embodiment of a system 6000;

FIG. 7 is a block diagram of an exemplary embodiment of a system 7000;

FIG. 8 is a block diagram of an exemplary embodiment of a system 8000;

FIG. 10 is a block diagram of an exemplary embodiment of a system 10000;

FIG. 11 is a block diagram of an exemplary embodiment of a system 11000;

FIG. 12 is a block diagram of an exemplary embodiment of a system 12000;

FIG. 13 is a block diagram of an exemplary embodiment of a system 13000;

FIG. 14 is a block diagram of an exemplary embodiment of a system 14000;

FIG. 15 is a block diagram of an exemplary embodiment of a system 15000;

FIG. 16 is a perspective view of a diagram of an exemplary embodiment of a fuel cell sheet 16000;

FIG. 17 is a perspective view of a diagram of an exemplary embodiment of a system 17000 comprising a fuel cell sheet;

FIG. 18 is a plan view of a diagram of an exemplary embodiment of a system 18000 comprising a fuel cell sheet;

FIG. 19 is a perspective view of a diagram of an exemplary embodiment of a fuel cell sheet 19000;

FIG. 20 is a perspective view of a diagram of an exemplary embodiment of a system 20000 comprising a fuel cell sheet;

FIG. 21 is a plan view of a diagram of an exemplary embodiment of a system 21000;

FIG. 22 is a block diagram of an exemplary embodiment of a system 22000;

FIG. 23 is a block diagram of an exemplary embodiment of a system 23000;

FIG. 24 is a block diagram of an exemplary embodiment of a system 24000;

FIG. 25 is a flowchart of an exemplary embodiment of a method 25000;

FIG. 26 is a block diagram of an exemplary embodiment of a system 26000;

FIG. 27 is a block diagram of an exemplary embodiment of a system 27000;

FIG. 28 is a block diagram of an exemplary embodiment of a system 28000; and

FIG. 29 is a block diagram of an exemplary embodiment of a system 29000.

### DEFINITIONS

When the following terms are used substantively herein, the accompanying definitions apply:
2-propanol—isopropyl alcohol or isopropanol. The chemical formula for 2-propanol is CH3-CHOH-CH3.
3-harness—three wooden or metal frames on a loom that lift and separate warp fibers so that filling fibers riding in a shuttle can pass through; a fabric that is made by lifting and separating three warp fibers so that filling fibers can pass through.
a—at least one.
activity—an action, act, step, and/or process or portion thereof.
adapted to—made suitable or fit for a specific use or situation.
adapter—a device used to effect operative compatibility between different parts of one or more pieces of an apparatus or system.
adhesive—a substance that adheres to a surface or causes adherence between surfaces.
adjacent—next to, but not necessarily touching.
airbrush—to spray with an atomizer, the atomizer adapted to use compressed air to spray a liquid.
amp—a unit of measure of electric current.
and/or—either in conjunction with or in alternative to.
anode—a site of an electrochemical cell at which oxidation takes place.
apparatus—an appliance or device for a particular purpose.
apply—to bring into contact with something; put on.
approximately—nearly the same as.
associated—related to.
bond—to attach.
bound—to limit an extent.
bundle—a plurality of assembled fibers.
bus—an electrical conductor that makes a common connection between a plurality of circuits.
can—is capable of, in at least some embodiments.
carbon particles—pieces of carbon having an average dimension of between approximately 1 nanometer and 1000 micrometers.
carrier—a substance to which an active ingredient or agent is added as a way of applying or transferring the ingredient or agent.
catalyst—a substance adapted to improve a chemical and/or electrochemical reaction rate. For example, a catalyst for a fuel cell can comprise platinum and/or other precious metals supported by carbon particles.
catalyst layer—a layer comprised of a mixture of a polymer and carbon particles adapted to conduct ions and electrons, and incorporating a catalyst in which fuel cell reactions occur.
catalyzed membrane gas permeable layer assembly—a system comprising a membrane electrode assembly sandwiched between a first gas permeable electrically conductive layer and a second gas permeable electrically conductive layer.
cathode—a site of an electrochemical cell at which reduction takes place.
centimeter—a metric unit of length equal to one hundredth of a meter.
centroidal axis—an axis perpendicular to a plane defined by a length and a width of a planar object and passing through a centroid of the planar object.
channel—a defined passage.
coat—(v) to apply a thin layer to cover something.
coated fabric—a plurality of fibers covered with a desired substance.
coil—to roll and/or form into a configuration having a substantially spiraled cross-section.
comprising—including but not limited to.
connect—to join or fasten together.
convey—to serve as a medium of transmission for.
coolant—a material adapted to transfer heat energy from a body.
corrugated—folded into parallel ridges and/or troughs.
count—a quantitative number of items.
coupleable—capable of being joined, connected, and/or linked together.
coupling—linking in some fashion.
current density—a quantitative measure of a flow of electrons over a predetermined area.
Darcy—a unit of permeability having units of area. One Darcy is equivalent to 0.986923 square microns.
Darcy permeability—a permeability measuring an ability of a fluid to flow through a porous media. The permeability is defined using Darcy's Law which can be written as:

$$v = \frac{κ Δ P}{μ Δ x}$$
where:
κ is the permeability of a medium
v is the superficial (or bulk) fluid flow rate through the medium
μ is the dynamic viscosity of the fluid
ΔP is the applied pressure difference
Δx is the thickness of the medium.
define—to establish the outline, form, or structure of.
degrees centigrade—a thermometric scale on which the interval between the freezing and boiling points of water is divided into 100 degrees with 0 degrees representing the freezing point and 100 degrees the boiling point.
determine—ascertain, obtain, and/or calculate.
device—a machine, manufacture, and/or collection thereof.
direct—(v) to cause to move in or follow a predetermined course.
directly—without an intervening source or sink of electrical current.
dispersion—a mixture of solid particles in a liquid.
dry—to remove a liquid from.
electrical terminal—an electrically conductive material electrically coupled to a fuel cell and electrically coupled to an electrical circuit adapted to be powered by the fuel cell.
electrically conductive—adapted to convey electrical energy.
electrically coupled—connected in a manner adapted to transfer electrical energy.
electrolyte layer—a polymer-based material of a defined thickness that is adapted to conduct ions.
epoxy coating—a layer on an object's surface, the layer comprising a thermosetting resin comprising cross-linked polymer structures.
extrude—to shape by forcing through a die.
fabric—a material formed by weaving, knitting, pressing, and/or felting natural or synthetic fibers.
fabricate—to make.
fiber—a natural or synthetic filament.
flow—(n) a stream and/or current.
fold—to bend.
form—(v) to cause something to develop or exist.
fuel cell—an electrochemical cell which captures and/or conveys electrical energy generated by a chemical reaction between fuels, such as hydrogen and oxygen.
gas permeable electrically conductive layer—an electrically conductive material of a defined thickness that is permeable to hydrogen, oxygen, nitrogen, water vapor, and liquid water.
gas-tight—substantially impermeable to oxygen and hydrogen.
greater—larger in magnitude.
heat—to apply thermal energy.
hydrogen—an element defined by each atom comprising a single proton and a single electron.
hydrogen ion—a hydrogen atom characterized by an absence of an electron in a substantially dedicated orbit around a nucleus of the hydrogen atom; a single proton lacking a corresponding electron.
hydrophobic material—a water repellant material.
in-plane thickness specific resistivity—for an electric current flowing in a thin sheet, the ratio of voltage drop in Volts per unit length to the current in Amps per unit width expressed in ohms or ohms per square.
install—to connect or set in position and prepare for use.
interconnect—a junction between two or more things.
interface—a surface forming a common boundary between adjacent bodies.
kilopascal—one thousand units of pressure. Each unit of pressure equal to one newton per square meter.
lateral axis—a straight line defined parallel to an object's width and passing through a centroid of the object.
length—a measurement of the extent of something along a greatest dimension.
locate—to position.
location—a place substantially approximating where something physically exists.
may—is allowed and/or permitted to, in at least some embodiments.
mat—a fabric comprising a plurality of fiber bundles.
membrane electrode assembly—a sandwich structure adapted to conduct hydrogen ions that comprises a proton electrolyte membrane between catalyzed electrolyte layers.
method—a process, procedure, and/or collection of related activities for accomplishing something.
micron—a unit of length equal to one millionth of a meter.
microporous sub-layer—a material of a defined thickness characterized by very small pores or channels with diameters ranging from approximately 1 nanometer to approximately 1000 micrometers.
millimeter—a metric unit of length equal to one thousandth of a meter.
mixture—a composition of two or more substances that are not chemically combined with each other and are capable of being separated.
molecule—a smallest particle of a substance that retains chemical and physical properties of the substance and comprises two or more atoms.
Non-collinear—not lying on or passing through a single straight line.
non-planar—not in, or associated with, a substantially flat surface.
not—in no way.
offset—separated by more than an insubstantial distance.
ohm—a unit of electrical resistance equal to that of a conductor in which a current of one ampere is produced by a potential of one volt across its terminals.
ohm per square—a unit of electrical resistance equal to that of a conductor in which a current of one ampere per unit width is produced by a potential of one volt per unit length.
oppose—to face away from.
opposite—facing away from.
overlap—(n) a part or portion that overlaps or is overlapped.
overlap—(v) to extend over and cover a part of.
oxygen—an element defined by each atom comprising eight protons and eight electrons.
pair—a set of two items.
parallel—of, relating to, or designating two or more straight coplanar lines that do not intersect.
parallel electrical coupling—an arrangement of components in an electrical circuit that splits an electrical current into two or more paths.
partially—to a degree; not totally.
perpendicular—of, relating to, or designating two or more straight coplanar lines or planes that intersect at approximately a right angle.
pitch fiber—a carbon fiber made from a highly viscous organic liquid.
place—to put in a particular place or position.
planar surface—a surface that is defined by a substantially flat plane.
plurality—the state of being plural and/or more than one.
polymer support—a porous matrix comprised of a polymeric material, the material adapted to define a space between one or more fuel cells.
polymeric—comprising one or more polymers.
polymeric material—a substance comprised of large molecules comprised of many chemically bonded smaller molecules.
polytetrafluoroethylene (PTFE)—a thermoplastic resin, (C₂F₄)ₙ, that is resistant to heat and chemicals and comprises a relatively low coefficient of friction.
portion—a part that is less than a larger whole.
predetermined—established in advance.
proton electrolyte membrane (PEM)—an electrolyte layer in a fuel cell that acts as a proton conducting electrolyte as well as a barrier film separating a cathode of the fuel cell from an anode of the fuel cell.
provide—to furnish and/or supply.
rate of reaction—a quantitative measure of how fast a chemical combination or decomposition takes place.
receive—accept something provided and/or given.
remove—to take off.
repeatedly—again and again; repetitively.
satin weave—a weave in which each of a plurality of filling fibers goes over a plurality of warp fibers before going under a warp fiber.
seal strip—a material adapted to at least partially define a channel adapted to direct a flow of a coolant.
section—a defined part of an object.
separated—not touching. Spaced apart by something.
series—an arrangement of components in an electrical circuit one after the other so that the electrical current is not split therebetween.
set—a related plurality.
side—a surface bounding a solid object.
sinter—to form a coherent mass by heating.
soak—to immerse in liquid and/or a predetermined environment for a period of time.
spacer strip—piece of a substance that is substantially impermeable to liquid water and that partially defines a channel adapted to conduct hydrogen and/or oxygen.
spun—produced via a process comprising twisting a plurality of raw fibers to form a continuous combination of fibers.
square centimeter—a determined area equivalent to that of a square having a length of one centimeter.
stretch broken—produced by stretching a plurality of fibers to a breaking point, thereby creating broken fibers comprising a range of lengths up to a defined upper limit.
substantially—to a great extent or degree.
support—to bear the weight of, especially from below.
system—a collection of mechanisms, devices, data, and/or instructions, the collection designed to perform one or more specific functions.
tab—a relatively small strip or attachment.
temperature—a measure of kinetic energy of a substance.
therefrom—from a place, time, or thing.
thickness—a quantitative measure of a dimension associated with an object.
through-plane area specific resistance—the electrical resistance of a conductor of unit area and specified length in the direction of current flow expressed in ohm-square centimeters.
usable—able to be put to use.
vapor grown—made via condensation of a gaseous substance.
via—by way of and/or utilizing.
volts—a basic measure of an electrical potential between two points on a conducting wire carrying a constant current of one ampere when the power dissipated between the points is one watt.
width—a measurement of the extent of something along a dimension.
woven—constructed by interlacing and/or interweaving strips or strands of material.
yield—to produce something.
z-strip—an electrically conductive material adapted to electrically couple a first fuel cell to a second fuel cell and comprising a zigzag cross-section. A z-strip is not a gas permeable electrically conductive layer.

### DETAILED DESCRIPTION

Certain exemplary embodiments comprise devices, systems, and methods associated with making and/or using a fabric. The fabric can comprise a hydrophobic coating. The fabric can comprise a microporous sub-layer. Certain exemplary embodiments comprise fuel cells and/or fuel cell structures adapted to utilize the fabric for one or more gas permeable electrically conductive layers.

Certain exemplary embodiments comprise making and/or using a fiber fabric adapted for use as a gas permeable electrically conductive layer, which can be used in a fuel cell. In certain exemplary embodiments, the fiber fabric can be a commercially available plain woven polyacrylonitrile (PAN) fiber diffusion media with a hydrophobic treatment and a microporous sub-layer. For example, the PAN fiber diffusion media can be an ELAT LT-1200W fabric available from E-TEK Inc. of Somerset, N.J.

In certain exemplary embodiments, the fiber fabric can an increased thickness PAN (ITPN) based carbon cloth with a microporous sub-layer (MSL), such as a 50 micron thick MSL. The ITPN fabric can be a 5-harness satin weave PAN fiber diffusion media with a greater thickness than the ELAT LT-1200W fabric

In certain exemplary embodiments, the fiber fabric can be a custom manufactured unidirectional pitch fiber (UNI), which can be a non-woven fiber mat comprised of unidirectional pitch fibers fabricated from a fiber bundle numbering, in fibers, an amount of approximately 500, 634, 1097, 1200, 4000, 5000, 6234, 7500, 10000, 23456, 35000, 42000, 47,875, 50,000, and/or any value or subrange therebetween. Certain exemplary embodiments can orient the fiber fabric so that a direction of highest conductivity of the fabric is aligned in a primary current direction.

Certain exemplary embodiments can comprise a fabric comprising a plurality of carbon fibers. The fabric can be formed by weaving, matting, felting, etc. Fibers comprised in the fabric oriented in the primary current carrying direction can be pitch carbon fibers greater in length than approximately one millimeter. Fibers comprised in the fabric in a fill direction can be chosen based upon characteristics not related to electrical conductivity. For example, fibers comprised in the fabric in the fill direction can be chosen based upon a tensile strength, shear strength, and/or any other property, etc.

In certain exemplary embodiments, the fiber fabric can be a coarsely woven pitch (CWPT) based carbon cloth fabric (e.g., a Mitsubishi-3HS fabric) with an applied MSL, which can be a 3-harness satin weave pitch fiber fabric, comprised of 5000 fiber bundles available from Mitsubishi Chemical America of Chesapeake, Va.

The fabric can comprise an epoxy coating and/or sizing, which can be removed by heat treatment. The fabric can comprise extruded, drawn, and/or spun fibers and can be woven with a satin weave. Fibers comprised in the fabric can be greater in length than approximately one half millimeter, and can comprise fibers of a length in millimeters greater than approximately 0.5, 0.7, 1, 2, 20.5, 50, 79.7, 198, 245.6, 479, 500, 823.2, 912, 1000, and/or any value or subrange therebetween. Fibers comprised in the fabric can be formed by weaving, matting, and/or felting, etc. Fibers comprised in the fabric might not be vapor grown, extruded, and/or stretch broken.

In certain exemplary embodiments, the fabric can be adapted for use as a gas permeable electrically conductive layer by heating the fabric to remove the epoxy coating and/or sizing.

In certain exemplary embodiments, a hydrophobic treatment and/or a microporous sub-layer (MSL) can be applied to the fabric to form a coated fabric. The hydrophobic treatment can be applied as a dispersion, followed by drying, curing, and/or sintering. The microporous sub-layer to the coated fabric to form a mat. The microporous sub-layer can be applied via a dispersion, airbrushing, spraying, brushing, tape casting, rolling, roll coating, reverse roll coating, knife coating, screen printing, and/or vacuum filtering, etc. The microporous sub-layer can be sintered with the fabric, which can consolidate the fabric and/or fabric bundles.

For example, the fabric can be soaked in a hydrophobic material to form the coated fabric. For example, the fabric can be soaked in a polytetrafluoroethylene (PTFE) dispersion, fluorinated ethylene-propylene (FEP) dispersion, and/or a polyvinylidene fluoride (PVDF) dispersion, etc. The PTFE dispersion can comprise approximately 60% PTFE, approximately 40% water, and/or surfactants to improve stability. The PTFE dispersion can comprise Teflon-30 available from DuPont, Inc. of Wilmington, De. The fabric can be dried after soaking the fabric in the hydrophobic material.

The MSL applied via a mixture of polytetrafluoroethylene (such as Teflon-30), carbon particles, and a carrier, such as 2-propanol (IPA). The mixture can be applied to the fabric to form a MSL of a thickness greater, in microns, than approximately a, 15, 20.1, 15, 40.8, 50, 98.6, 100, 144, 150, 180, 245.5, 500, and/or any value or subrange therebetween. The mixture can comprise components mixed to form an ink (e.g. approximately 1% by weight of Teflon-30; approximately 3% by weight of carbon particles; and approximately 96% by weight of IPA). In certain exemplary embodiments, carbon particles can be obtained, such as those sold under the trade name of Vulcan XC-72R from Cabot Corp. of Boston, Mass. After forming the microporous sub-layer, the fabric can be dried at a temperature greater than approximately, in degrees centigrade, 100, 227.6, 250, 289.3, 327, 335.9, 354.3, 350 and any value or subrange therebetween. After drying the MSL, the fabric can be sintered at a temperature greater than approximately, in degrees centigrade, 200, 227.6, 250, 289.3, 327, 335.9, 354.3, 500 and any value or subrange therebetween. The MSL can be located on a side of the fabric adapted to be adjacent to a catalyst layer comprised in a fuel cell.

The mat can comprise a plurality of pitch fibers in a satin weave. For example, a modified Mitsubishi-3HS fabric can comprise an in-plane thickness specific resistivity of less than approximately 0.2 ohms/square and a through-plane area specific resistance of less than approximately 0.02 ohm-cm² when compressed at approximately 500 kPa and an uncompressed Darcy permeability greater than approximately 20 Darcys. When adapted for use as an in-plane current collector in a fuel cell, the combination of a membrane electrode assembly and two gas permeable electrically conductive layers can be adapted to yield a fuel cell current density of at least 0.22 amps per square centimeter of said membrane electrode assembly when a voltage differential between one end of an anode gas distribution layer and an opposite end of a cathode gas distribution layer is approximately 0.5 volts when said ends are separated by a width of approximately three centimeters.

Certain exemplary embodiments can achieve a lower in-plane resistance by increasing a thickness and/or fiber density (fibers/cm) of certain woven structures utilizing PAN based yarns. Fabrics thereby obtained can be referred to as an increased thickness PAN (ITPN) based carbon cloth series diffusion media, which can be adapted to make fuel cell gas permeable electrically conductive layers. ITPN woven carbon cloths can comprise twisted carbon fiber yarns containing six tows. Each tow can comprise approximately 200 PAN based carbon fibers. Due to an increased size of yarns used in ITPN woven carbon cloths compared comparable cloths produced from an ELAT LT-1200W fabric, the ITPN woven carbon cloths can be approximately two to three times a thickness of a woven structure comprised in the ELAT LT-1200W fabric. The ITPN woven carbon cloths can comprise a 5-harness satin weave (5HS), which can be used to arrange warp and fill yarns. The 5HS weave allows for yarns comprised therein to be in contact with a catalyst layer over a greater area than might be possible with a plain weave fabric. The ITPN based carbon cloth series diffusion media can be purchased in an untreated form from E-TEK Inc. of Somerset, N.J.

Certain exemplary embodiments can comprise graphitized mesophase pitch fibers instead of more common PAN based fibers. Mesophase pitch based carbon fibers can be commercially available in tows of 1000 fibers or more. A structure of woven pitch based fiber fabrics can be coarse in comparison to woven structure comprising PAN based yarns. Mesophase pitch based carbon fibers can have a lower electrical resistance in each fiber than PAN based yarns.

A coarsely woven pitch (CWPT) based carbon cloth can be acquired from Mitsubishi Chemical of America Inc. of Chesapeake, Va. The CWPT can comprise a coating and/or sizing, such as a two percent epoxy sizing, which can be removed by heat treatment prior to use in making a gas permeable electrically conductive layer adapted for use in a fuel cell. The CWPT can comprise single tows of 2000 fibers each. A weave construction of the CWPT material can be a two-by-one twill, which can be characterized as a 3-harness satin (3HS) weave where fill tows can pass over a top of two warp tows prior to passing under a single warp tow.

In certain exemplary embodiments, adding a hydrophobic polymer to a bulk structure of gas diffusion media can enhance water and gas transport characteristics thereof. The ELAT LT-1200W fabric can be supplied with a hydrophobic treatment already applied. For ITPN and CWPT gas diffusion materials, bulk treatments can be applied. Each of the ITPN and CWPT diffusion material can be treated in two different manners, creating a total of four exemplary embodiments of gas diffusers. Treatment A can comprise coating materials with a polymer material, such as PTFE, in order to increase hydrophobicity. Treatment B can comprise coating materials with a polymer material, such as PTFE, and carbon black. Carbon black can reduce a bulk resistivity, and in particular a through-plane resistivity.

A homogenous suspension of DuPont Teflon (PTFE) can be used for hydrophobic treatments of diffusion media. PTFE content in each diffusion material can be based on an original untreated mass of each diffusion media. A mass of PTFE equal to approximately 25 percent by weight of an untreated diffusion media mass can be added to each substrate material for both treatments A and B.

Treatment B can comprise an addition of a polymer material, such as PTFE, equal to approximately 25 percent by weight of the original untreated substrate mass as well as carbon black. A value of approximately 40 percent by weight of the original untreated mass can be chosen for a total mass of the polymer material and carbon black treatments combined, where 62.5 percent by weight of the total mass comprises the polymer material, and 37.5 percent by weight comprises Vulcan XC-72R carbon black.

The application of each treatment can comprise soaking untreated woven cloths in respective treatments. Each diffusion media substrate can be weighed, soaked in either treatment A or B, dried (such as at a temperature of approximately 140 degrees centigrade for approximately 30 minutes to evaporate a carrier such as isopropyl alcohol and/or de-ionized water) and weighed to determine an added mass of a particular treatment. This process can be repeated until a desired addition of mass is achieved. A mass addition quantity can be controlled by a level of dilution of a dispersion comprising the carrier and the polymer material and/or a time during which each material is soaked. Following the addition of a desired mass, diffusion media materials can be heat treated at approximately 180 degrees centigrade for approximately 30 minutes, approximately 280° C. for approximately 30 minutes, and/or sintered at approximately 350 degrees centigrade for approximately 30 minutes according to the process observed in the literature.

In certain exemplary embodiments, each diffusion media can be soaked for approximately one minute in an aqueous suspension comprising five to ten percent by weight of the polymer material for treatment A. A suspension comprising approximately five percent by weight of the polymer material can be used for the ITPN material since the higher porosity of the ITPN material can allow, in relative terms, more of the suspension to be absorbed. A soaking process for treatment A might only be performed once for each material.

The mixture used to apply treatment B can comprise dispersing a polymer material, such as PTFE, and carbon black particles in isopropyl alcohol (IPA), followed by ultrasonic agitation. An amount of IPA comprised in the dispersion can be approximately fifty times a mass of the polymer material. Greater dilution can result in longer soaking times for an application of treatment B. In certain exemplary embodiments, a desired mass can be achieved by soaking diffusion media in the carbon black/PTFE/IPA suspension for approximately five minutes, followed by drying at approximately 140 degrees centigrade. In certain exemplary embodiments, the soaking process can be repeated four to six times to achieve a desired concentration of PTFE and carbon black.

In certain exemplary embodiments, a microporous sublayer (MSL) on gas diffusion materials can comprise a polymer material, such as PTFE, and carbon black. The MSL can be adapted to enhance performance of PEM fuel cells. In certain exemplary embodiments, a thick MSL with a high content of the polymer material can provide a smooth and compatible interface for adhesion of a gas permeable electrically conductive layer to a catalyst later in a PEM fuel cell. In certain exemplary embodiments, a thin MSL comprising carbon black can provide a relatively low bulk through-plane resistance of the MSL. The through-plane resistance of the MSL might have an effect in fuel cell ribbons, but the in-plane resistance might not impact performance since the layer can be thin relative to low resistivity substrate materials comprised in gas permeable electrically conducting layers in fuel cell ribbons. In certain exemplary embodiments, MSL dispersions can comprise approximately ten to thirty percent by weight of the polymer material. In certain exemplary embodiments, a total MSL loading of approximately 1.25-3.0 milligrams per square centimeter on fabrics can be utilized. Certain exemplary embodiments can comprise a loading which makes up one third of the total thickness of the diffusion media. Certain exemplary embodiments can comprise a MSL comprising approximately 90 percent by weight of carbon black and approximately 10 percent by weight of a polymer material, such as PTFE.

The MSL can be applied via a variety of techniques such as dispersion, airbrushing, spraying, brushing, tape casting, rolling, roll coating, reverse roll coating, knife coating, screen printing, and/or vacuum filtering, etc. The ITPN material can comprise a smooth surface due to the small twisted yarns used to construct the weave, and a 5HS weave pattern, which can be used to fabricate the cloth. Due to the smooth surface, a relatively thin MSL might be applied. In certain exemplary embodiments, application of the MSL using an airbrush can provide a uniformly thick and smooth surface, which can be adhered to the MEA. A target MSL loading for the ITPN material might be 1.5 milligrams per square centimeter. In certain exemplary embodiments, the MSL can be sprayed onto the ITPN material utilizing an airbrush due to simplicity and a uniform thickness associated with this method of application.

Application of an MSL using an airbrush can be adapted to provide a MSL of a relatively uniform thickness and loading. A uniform thickness might be desirable if a material to which the MSL is applied being comprises a relatively smooth surface such as the ITPN cloth. But, application of a uniformly thick MSL to a material with an uneven surface might result in a MPL, which can follow the surface contours. Due to uneven surfaces of the CWPT material, application of a MSL using an airbrush might not be desirable. In certain exemplary embodiments, the MSL can be applied to the CWPT material using a tape casting technique. The tape casting technique can be adapted to apply a smooth surface and fill in contours of surfaces to which the tape casting is applied. Due to surface contours comprised in the CWPT material, a certain MSL loading might not be specified since the loading can vary from point to point on a particular diffusion media. In certain exemplary embodiments, an applied MSL can be approximately one half of an average thickness of a CWPT material.

A mixture of approximately ten percent by weight of a polymer material (e.g., PTFE) and approximately ninety percent by weight of carbon black (e.g., Vulcan XC-72R carbon black) can be suspended in a carrier (e.g., isopropyl alcohol) to create ink for MSL application. To achieve such a suspension, the polymer material can be mixed with the carrier in a ratio of approximately one part polymer material to three hundred parts carrier by mass. A 300:1 ratio can be adapted to suspend carbon black within the carrier. In certain exemplary embodiments, the MSL can be applied using an airbrush (such as to the ITPN substrate). In certain exemplary embodiments, the MSL ink can be used in the freshly prepared state. In certain exemplary embodiments, a more viscous suspension can be utilized for tape casting.

For the ITPN material, the ink can be applied by using an airbrush with an adjustable air/ink ratio to increase or decrease a flow rate and atomization of ink at a nozzle exit. Optimal settings on the airbrush can be determined via analyses of MSL surfaces and cross sections using scanning electron microscopy (SEM). Prior to applying MSL ink or paste onto a diffusion media, a thickness of the media can be measured using an electronic digital caliper, and a mass can be recorded using a digital scale. Following application of a MPL, a diffusion media can be dried at approximately 140 degrees centigrade to evaporate any remaining carrier. The diffusion media can be subsequently measured and weighed. Application processes can be repeated until a desired loading is achieved. Once the MSL application is completed, the diffusion media can be heat treated at approximately 140 degrees centigrade for 30 minutes, 280 degrees centigrade for 30 minutes, and sintered at 350 degrees centigrade for 30 minutes, in order to thoroughly dry the layer and sinter the PTFE particles.

TABLE I

| | In-plane | | |
|---|---|---|---|
| | thickness | | |
| | specific | Through-plane area | |
| | resistance at | specific resistance at 500 | |
| | 500 kPa (ohms | kPa (ohms-square | Permeability |
| Material | per square) | centimeter) | (Darcys) |
| ITPN-A | 0.180 | 0.0167 | >20 |
| ITPN-B | 0.170 | 0.0128 | >20 |
| CWPT-A | 0.042 | 0.0141 | >20 |
| CWPT-B | 0.036 | 0.0127 | >20 |

Table I presents a summary of properties of certain exemplary gas diffusion media.

TABLE II

| Substrate | Tow size | | Thickness, |
|---|---|---|---|
| material | (# of fibers) | Yarn construction | microns |
| ELAT | 200 | 2 ply - twisted | 300 |
| ITPN | 200 | 6 ply - twisted | 600 |
| CWPT | 2000 | single ply - no twist | 380 |

Table II presents a summary of characteristics of certain exemplary gas diffusion media substrates.

TABLE III

| | Added bulk | MPL loading | Approximate | Final |
|---|---|---|---|---|
| Diffusion | treatment (% | (milligrams per | MSL | treated |
| media | original | square | thickness, | thickness, |
| designation | mass) | centimeter) | microns | microns |
| ELAT | Unknown | Unknown | 110 | 410 |
| ITPN-A | 30 | 1.7 | 50 | 950 |
| ITPN-B | 46 | 1.6 | 50 | 1050 |
| CWPT-A | 24 | 4.3 | 180 | 550 |
| CWPT-B | 38 | 4.3 | 180 | 620 |

Table III presents a summary of characteristics of certain exemplary treated gas diffusion media.

In certain exemplary embodiments, a carbon fiber fabric can comprise an in-plane thickness specific resistivity of less than 0.2 ohms/square and a through-plane area specific resistance of less than 0.02 ohm-square centimeters when compressed at 500 kPa and an uncompressed Darcy permeability greater than 20 Darcys. When adapted for use as an in-plane current collector in a fuel cell, the combination of a membrane electrode assembly and two gas permeable electrically conductive layers can be adapted to yield a fuel cell current density of greater than 0.25 amps per square centimeter when 0.5 volts is applied to a fuel cell width of approximately three centimeters.

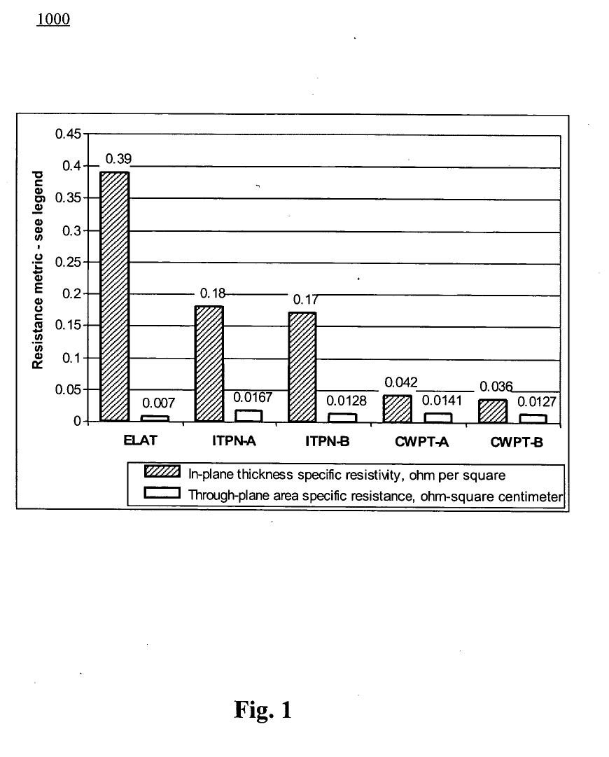

FIG. 1 is a graph showing results for a test of certain exemplary embodiments for in-plane and through-plane resistance of certain diffusion media samples. Certain exemplary embodiments of the CWPT fabric were tested to have a lower resistance levels than certain exemplary embodiments utilizing the ELAT LT-1200W fabric and certain exemplary embodiments utilizing the ITPN fabric.

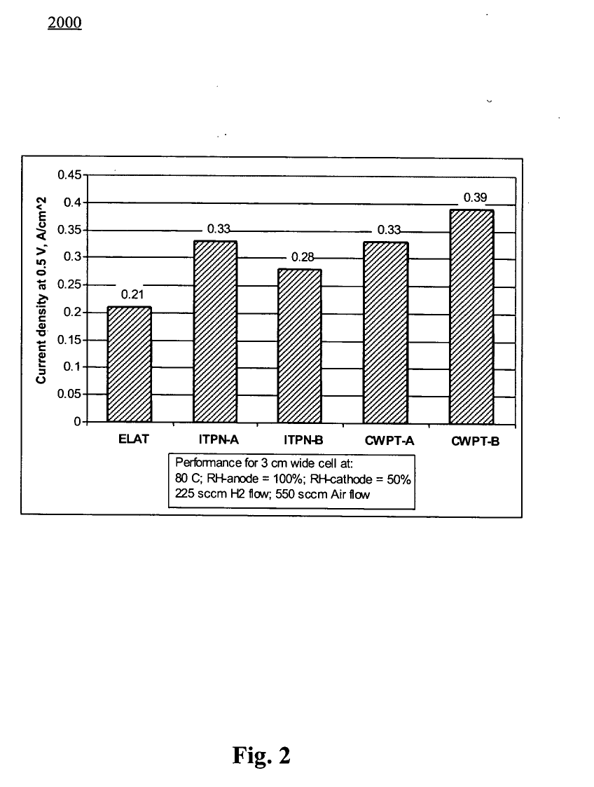

FIG. 2 is a graph showing results for current density tests of certain exemplary embodiments of diffusion media. The performance of fuel cells comprised of the exemplary embodiments and a membrane electrode assemblies (MEAs) were determined experimentally in a ribbon fixture that applied compression but that was fabricated from an electrical insulator (polyetherimide (PEI)) so that current was conducted laterally through a gas distribution layer. Tests were conducted in a fuel cell that was approximately three centimeters wide at a temperature of approximately 80 degrees centigrade. The anode operated in an atmosphere of 100 percent relative humidity. The cathode operated in an atmosphere of 50 percent relative humidity. The fuel cell was supplied with 225 standard cubic centimeters per minute (sccm) of hydrogen. The fuel cell was supplied with 550 sccm of oxygen.

For current collection using ELAT, experimental results indicated a current density at 0.5 V of 0.21 Amps per square centimeter. For ITPN-A material, which comprised a hydrophobic treatment (Treatment A), experimental results indicated a current density at 0.5 V of 0.33 Amps per square centimeter. For ITPN-B, which comprised a hydrophobic treatment that also comprised carbon particles (Treatment B), experimental results indicated a current density at 0.5 V of 0.28 Amps per square centimeter. For CWPT, experimental results indicated a current density at 0.5 V of 0.33 Amps per square centimeter for CWPT with a hydrophobic treatment (Treatment A). For CWPT with a hydrophobic treatment that also comprised carbon particles (Treatment B), experimental results indicated a current density at 0.5 V of 0.39 Amps per square centimeter.

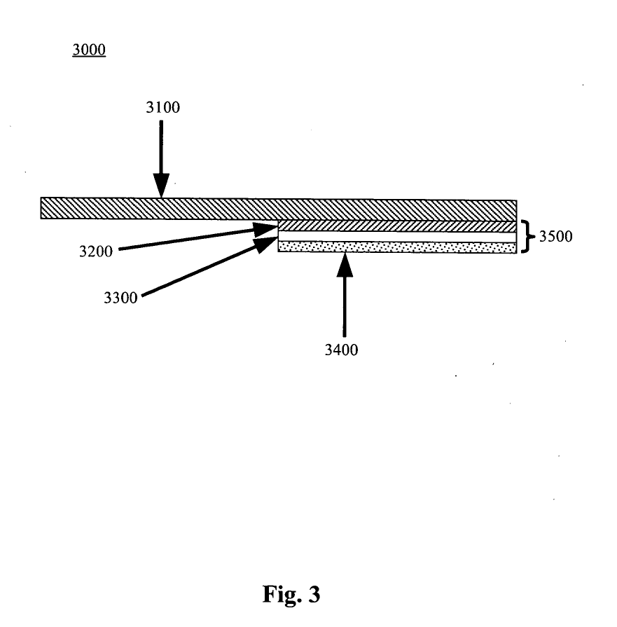

FIG. 3 is a block diagram of an exemplary embodiment of a system 3000, which can be adapted to be a portion of a fuel cell. System 3000 can comprise a gas permeable electrically conductive layer 3100, which can be bonded to a first catalyzed electrolyte layer 3200, such as with an adhesive and/or via hot pressing gas permeable electrically conductive layer 3100 and first catalyzed electrolyte layer 3200. Gas permeable electrically conductive layer 3100 can comprise a relatively low resistivity (such as a resistivity as good or better than fabrics comprised in Table I). Gas permeable electrically conductive layer 3100 can comprise PAN fibers, and/or pitch fibers. In certain exemplary embodiments, gas permeable electrically conductive layer 3100 can comprise a hydrophobic coating and/or a microporous sublayer. First catalyzed electrolyte layer 3200 can be bonded to a proton electrolyte membrane (PEM) 3300. PEM 3300 can be bonded to a second catalyzed electrolyte layer 3400. In certain exemplary embodiments, first catalyzed electrolyte layer 3200 can serve as an anode in a fuel cell. In certain exemplary embodiments, second catalyzed electrolyte layer 3400 can serve as a cathode in the fuel cell.

In certain exemplary embodiments, first catalyzed electrolyte layer 3200, PEM 3300, and/or second catalyzed electrolyte layer 3400 can comprise a sulfonated tetrafluorethylene polymer, such as Nafion, and/or biphenyl sulfones (BPSH), sulfonated Diels-Alder polyphenylene (SDAPP), sulphonated hydrocarbons, etc. Nafion is available from DuPont, Inc.

First catalyzed electrolyte layer 3200 and/or second catalyzed electrolyte layer 3400 can comprise a first catalyst, which can comprise a precious and/or other metal, such as platinum, palladium, rhodium, ruthenium, gold, silver, copper, nickel, and/or cobalt, etc., adapted to enhance a reaction rate for separating an electron from a hydrogen atom and/or a reaction rate between hydrogen ions and oxygen molecules.

The assembly of first catalyzed electrolyte layer 3200, PEM 3300, and second catalyzed electrolyte layer 3400 can be comprised in a membrane electrode assembly (MEA) 3500, which can be purchased commercially, such as from Ion Power of New Castle, Del. and can be specified as Nafion N112. Nafion 112 can comprise a catalyst loading of approximately 0.3 milligrams of carbon supported platinum catalyst per square centimeter on each side of membrane.

In certain exemplary embodiments, fuel cell systems produced utilizing certain exemplary mats can rely on the gas permeable electrically conductive layer, rather than bipolar plates, to collect and/or transport current and/or electrons to the next cell in the stack. Thus, fuel cell systems produced utilizing certain exemplary mats can be fabricated such that they lack bipolar plates.

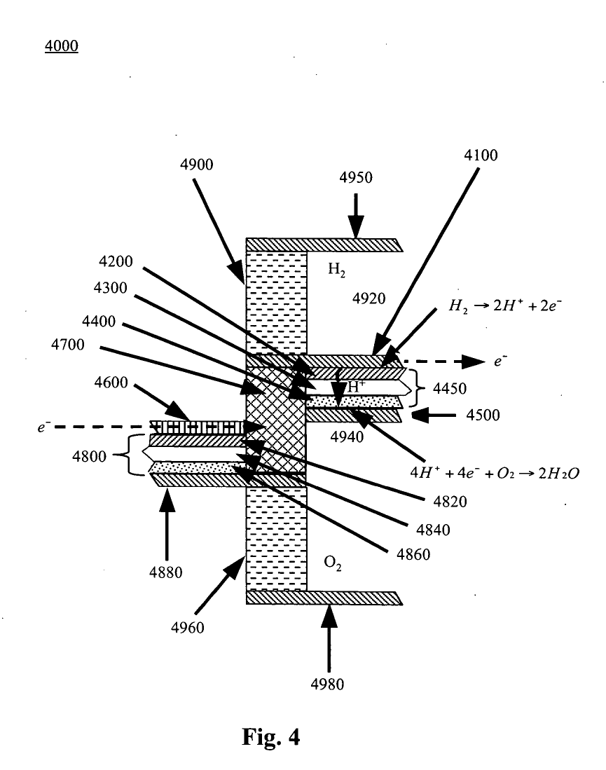

FIG. 4 is a block diagram of an exemplary embodiment of a system 4000, which can comprise a first gas permeable electrically conductive layer 4100. Gas permeable electrically conductive layers comprised in system 4000, such as first gas permeable electrically conductive layer 4100, can comprise PAN fibers, and/or pitch fibers. First gas permeable electrically conductive layer 4100 can be substantially parallel to, and located adjacent and/or bonded to, a first anode 4200. First anode 4200 can be a first catalyzed electrolyte layer. First anode 4200 can be substantially parallel to, and located adjacent and/or bonded to, a first PEM 4300. First PEM 4300 can be located adjacent to an opposing side of first anode 4200 from a side of first anode 4200 located adjacent to first gas permeable electrically conductive layer 4100. First PEM 4300 can be substantially parallel to, and located adjacent and/or bonded to, a first cathode 4400. First cathode 4400 can be a second catalyzed electrolyte layer. First cathode 4400 can be located adjacent to an opposing side of first PEM 4300 from a side of first PEM 4300 located adjacent to first anode 4200. A first MEA 4450 can comprise first anode 4200, first PEM 4300, and first cathode 4400. First cathode 4400 can be substantially parallel to, and located adjacent and/or bonded to, a second gas permeable electrically conductive layer 4500. Second gas permeable electrically conductive layer 4500 can be located adjacent to an opposing side of first cathode 4400 from a side of second catalyzed electrolyte layer 4400 located adjacent to first PEM 4300. Gas permeable electrically conductive layers comprised in system 4000, such as first gas permeable electrically conductive layer 4100 and/or second gas permeable electrically conductive layer 4500, can be adapted to convey oxygen, liquid water, and/or water vapor. Each of first gas permeable electrically conductive layer 4100, first anode 4200, first PEM 4300, first cathode 4400, and second gas permeable electrically conductive layer 4500 can be comprised by a first fuel cell.

Hydrogen can be provided to the first fuel cell via a first channel 4920, which can be adapted to direct a flow of hydrogen. In certain exemplary embodiments, first channel 4920 can be a hydrogen filled channel. In certain exemplary embodiments, first channel 4920 can be filled with a material porous with respect to hydrogen that is resistant to acidic environments at a pH of approximately three or above. In certain exemplary embodiments, the material porous to hydrogen can be Gore-Tex material (available from Gore Corporation of Elkton, Md.), Teflon (available from DuPont, Inc. of Wilmington, De.) or a porous material that can comprise one or more of polyvinylidene fluoride (PVDF) (available from DuPont, Inc. of Wilmington, De.), and/or any other porous acid-resistant polymer material, etc. First gas permeable electrically conductive layer 4100 and a fifth gas permeable electrically conductive layer 4950 can partially define first channel 4920. Fifth gas permeable electrically conductive layer 4950 can be substantially parallel to first gas permeable electrically conductive layer 4100 and separated therefrom by a first spacer 4900. First spacer 4900 can partially define first channel 4920. First spacer 4900 can be located adjacent to first gas permeable electrically conductive layer 4100. First spacer 4900 can be located adjacent to an opposing side of first gas permeable electrically conductive layer 4100 from a side of first gas permeable electrically conductive layer 4100 located adjacent to first catalyzed electrolyte layer 4200. First spacer 4900 can be fabricated from any electrically nonconductive material such as a polymer, elastomer, plastic, fluorinated elastomer, thermoplastic elastomer, silicone, PTFE, PVDF, and/or ceramic, etc. First spacer 4900 and/or a second spacer 4960 can comprise one or more reinforcements adapted to increase structural strength. For example, the one or more reinforcements can comprise a metal and/or a polymer.

Oxygen can be provided to the first fuel cell via a second channel 4940, which can be adapted to direct a flow of oxygen. In certain exemplary embodiments, second channel 4940 can be an air filled channel. In certain exemplary embodiments, second channel 4940 can be filled with a material porous with respect to oxygen. Second gas permeable electrically conductive layer 4500, second spacer 4960, and a sixth gas permeable electrically conductive layer 4980 can partially define second channel 4940. Sixth gas permeable electrically conductive layer 4980 can be substantially parallel to second gas permeable electrically conductive layer 4500 and separated therefrom by a plurality of layers comprising second spacer 4960 and a fourth gas permeable electrically conductive layer 4880.

In certain exemplary embodiments, hydrogen can flow via first channel 4920 to first gas permeable electrically conductive layer 4100. Hydrogen can flow through first gas permeable electrically conductive layer 4100 to an interface of first gas permeable electrically conductive layer 4100 and first anode 4200. Electrons can be separated from hydrogen ions at a location at or near the first anode 4200. The electrons can be conducted via first gas permeable electrically conductive layer 4100 to an electrical terminal and/or another fuel cell. If the electrons are conducted to an electrical terminal, the electrons can be adapted to provide an electrical current to an electrical device. If the electrons are conducted to another fuel cell, the electrons can combine with hydrogen ions and oxygen molecules to form water and release energy. In certain exemplary embodiments, hydrogen ions can flow via first anode 4200, first PEM 4300, and first cathode 4400 to an interface of first cathode 4400 and second gas permeable electrically conductive layer 4500. The hydrogen ions can be combined with electrons and oxygen molecules to form water and release energy at the first cathode 4400. The oxygen molecules can flow to the interface of first cathode 4400 and second gas permeable electrically conductive layer 4500 from second channel 4940 via second gas permeable electrically conductive layer 4500.

Third gas permeable electrically conductive layer 4600 can be comprised by a second fuel cell. An overlap portion of third gas permeable electrically conductive layer 4600 can overlap, be bonded to, and/or be substantially parallel to an overlap portion of second gas permeable electrically conductive layer 4500 via an electrically conductive adhesive and/or sealant 4700. In certain exemplary embodiments, electrically conductive adhesive and/or sealant 4700 can be gas-tight and/or water-tight. Electrically conductive adhesive and/or sealant 4700 can comprise a carrier such as epoxy and/or silicone. Electrically conductive adhesive and/or sealant 4700 can comprise an electrically conductive material such as carbon, silver, gold, platinum, palladium, any other electrically conductive noble material, and/or any combination thereof, etc. Via electrically conductive adhesive and/or sealant 4700, a gas-tight and/or water-tight interconnect can be formed between third gas permeable electrically conductive layer 4600 and second gas permeable electrically conductive layer 4500. In certain exemplary embodiments, electrically conductive adhesive and/or sealant 4700 can be a Master Bond Mastersil 705S adhesive available from Master Bond, Inc. of Hackensack N.J. First cathode 4400 can be located adjacent to an opposing side of second gas permeable electrically conductive layer 4500 from a side of second gas permeable electrically conductive layer 4500 adjacent to the overlap portion of third gas permeable electrically conductive layer 4600.

The second fuel cell can comprise membrane electrode assembly 4800, which can comprise layers such as second anode 4820, second PEM 4840, and second cathode 4860. Structurally and functionally, layers comprised in membrane electrode assembly 4800 can be similar to those of first anode 4200, first PEM 4300, and first cathode 4400. The second fuel cell can be electrically coupled in series with the first fuel cell.

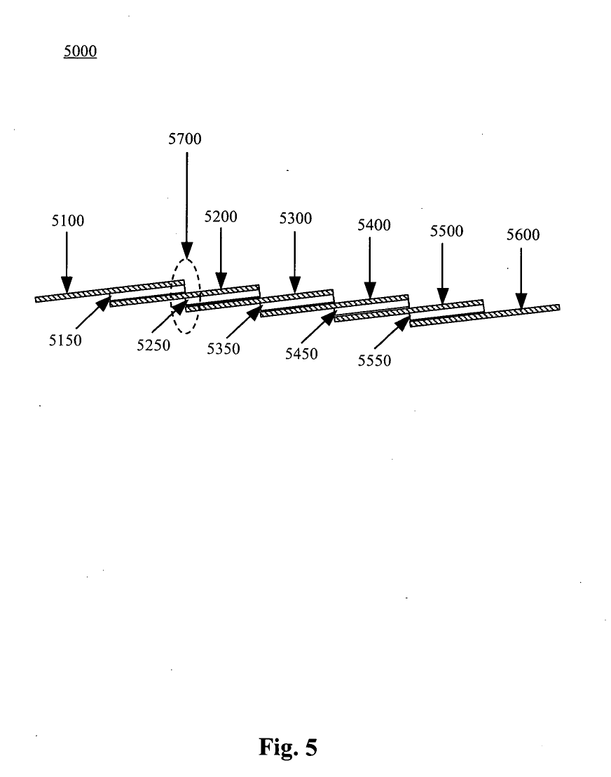

FIG. 5 is a block diagram of an exemplary embodiment of a system 5000, which can comprise a plurality of gas permeable electrically conductive layers such as a first gas permeable electrically conductive layer 5100, a second gas permeable electrically conductive layer 5200, a third gas permeable electrically conductive layer 5300, a fourth gas permeable electrically conductive layer 5400, a fifth gas permeable electrically conductive layer 5500, and a sixth gas permeable electrically conductive layer 5600. System 5000 can comprise a plurality of MEAs such as a first MEA 5150, a second MEA 5250, a third MEA 5350, a fourth MEA 5450, and a fifth MEA 5550. At each interface between fuel cells, such as at an interface 5700, system 5000 can comprise a plurality of gas-tight and/or water-tight seals. For example, at interface 5700 second gas permeable electrically conductive layer 5200, first MEA 5150, and/or second MEA 5250 can comprise one or more portions infused, impregnated, and/or permeated with a polymeric adhesive and/or sealant adapted to form a gas-tight seal between fuel cells. In certain exemplary embodiments, the polymeric adhesive and/or sealant can be electrically insulating. System 5000 can be adapted for use, in configurations such as shown in FIG. 9, in forming a plurality of fuel cells.

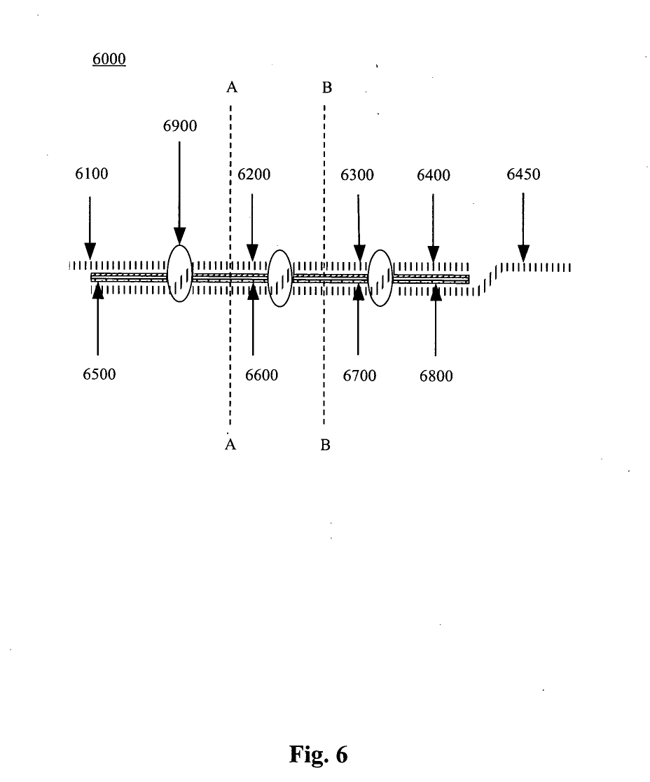

FIG. 6 is a block diagram of an exemplary embodiment of a system 6000, which can comprise a plurality of gas permeable electrically conductive layers such as a first gas permeable electrically conductive layer 6100, a second gas permeable electrically conductive layer 6200, a third gas permeable electrically conductive layer 6300, a fourth gas permeable electrically conductive layer 6400, and a fifth gas permeable electrically conductive layer 6450. The plurality of gas permeable electrically conductive layers can comprise PAN fibers, pitch fibers, and/or metal, etc. System 6000 can comprise a plurality of MEAs such as a first MEA 6500, a second MEA 6600, a third MEA 6700, and a fourth MEA 6800. First MEA 6500 can define a first lateral axis. Second MEA 6600 can define a second lateral axis. Third MEA 6700 can define a third lateral axis. Fourth MEA 6800 can define a fourth lateral axis. In certain exemplary embodiments, the first lateral axis, the second lateral axis, the third lateral axis, and/or the fourth lateral axis can each be approximately colinear. Each of first MEA 6500, second MEA 6600, third MEA 6700, and fourth MEA 6800 can be comprised in a respective fuel cell. In certain exemplary embodiments fuel cells comprising MEA 6500, second MEA 6600, third MEA 6700, and fourth MEA 6800 can be electrically coupled respectively by second gas permeable electrically conductive layer 6200, third gas permeable electrically conductive layer 6300, fourth gas permeable electrically conductive layer 6400. Each junction between electrically coupled fuel cells can be sealed by a gas-tight seal, such as a seal 6900 between a first fuel cell comprising first MEA 6100 and a second fuel cell comprising second MEA 6200. In certain exemplary embodiments, seal 6900 can be electrically insulating, gas-tight, and/or water-tight.

Second MEA 6600 can define a first centroidal axis A perpendicular to a planar surface of first MEA 6600. Third MEA 6700 can define a second centroidal axis B perpendicular to a planar surface of third MEA 6700. First centroidal axis A can be substantially non-collinear with second centroidal axis B.

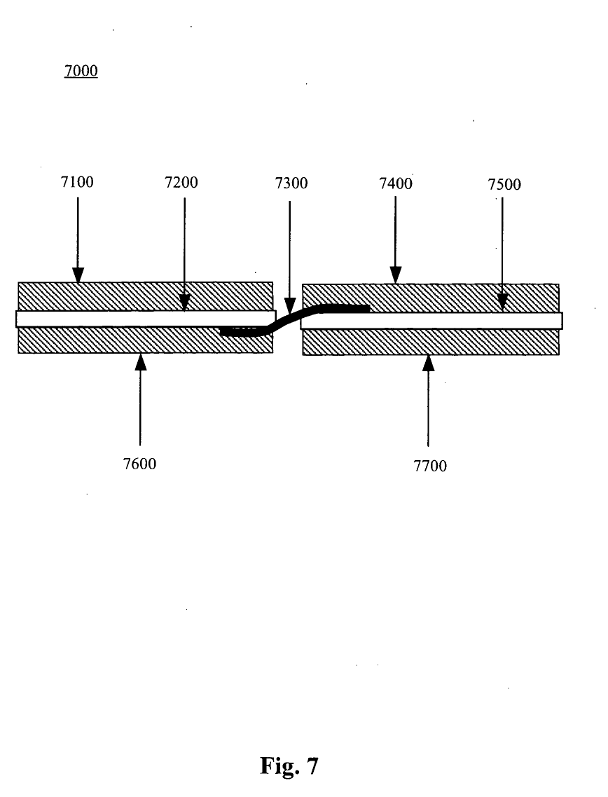

FIG. 7 is a block diagram of an exemplary embodiment of a system 7000. System 7000 can comprise a first gas permeable electrically conductive layer 7100, a second gas permeable electrically conductive layer 7600, a third gas permeable electrically conductive layer 7400, and a fourth gas permeable electrically conductive layer 7700. System 7000 can comprise a first MEA 7200 and a second MEA 7500. System 7000 can comprise an electrical interconnect 7300, which can be adapted to electrically couple second gas permeable electrically conductive layer 7600 to third gas permeable electrically conductive layer 7400. Electrical interconnect 7300 can be a z-strip as illustrated in FIG. 7 and/or a tab comprised in second gas permeable electrically conductive layer 7600. In certain exemplary embodiments, electrical interconnect 7300 can be adapted to fully and/or partially form a gas-tight seal between a fuel cell comprising first MEA 7200 and a second fuel cell comprising second MEA 7500.

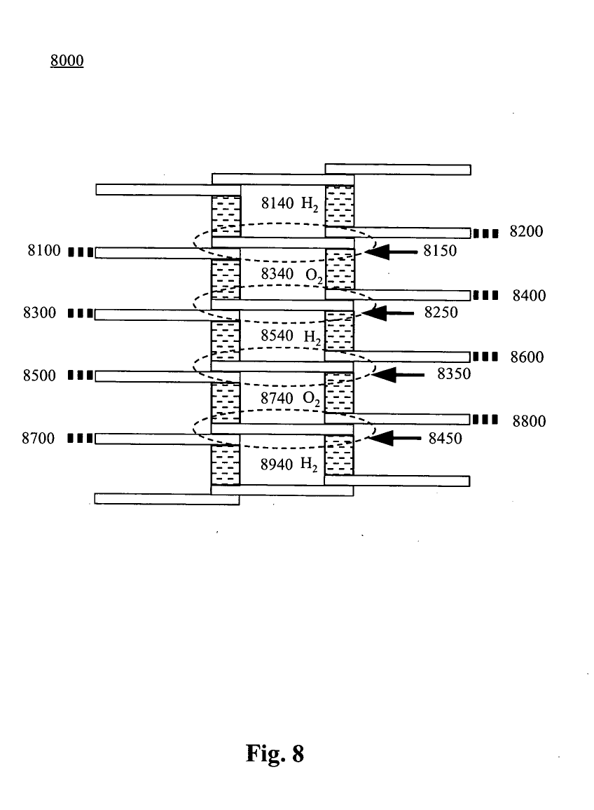

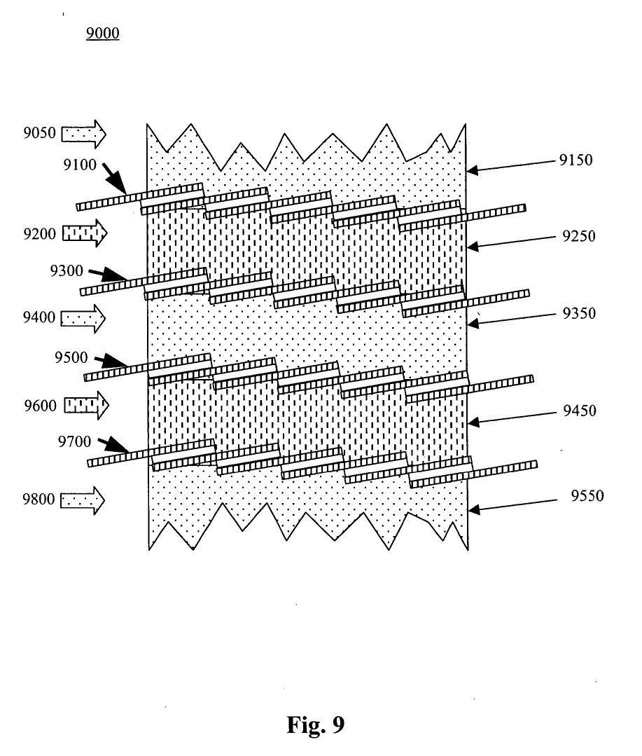

FIG. 8 is a block diagram of an exemplary embodiment of a system 8000, which can comprise a plurality of positive terminal connections such as a first positive terminal connection 8100, a second positive terminal connection 8300, a third positive terminal connection 8500, a fourth positive terminal connection 8700. System 8000 can comprise a plurality of negative terminal connections such as a first negative terminal connection 8200, a second negative terminal connection 8400, a third negative terminal connection 8600, a fourth negative terminal connection 8800. In certain exemplary embodiments, a plurality channels can be formed, such as a plurality of channels adapted to direct a flow of hydrogen. For example, system 8000 can comprise a first hydrogen channel 8140, a second hydrogen channel 8540, and a third hydrogen channel 8940. Certain exemplary embodiments can comprise a plurality of channels adapted to direct a flow of oxygen. For example, system 8000 can comprise a first oxygen channel 8340, and a second oxygen channel 8740. System 8000 can comprise a plurality of fuel cells such as a first fuel cell 8150, a second fuel cell 8250, a third fuel cell 8350, and a fourth fuel cell 8450.

Each of first fuel cell 8150, second fuel cell 8250, third fuel cell 8350, and fourth fuel cell 8450 can comprise a MEA, a supply of hydrogen, a supply of oxygen, a path for electrons to flow away from an anode of each MEA, and a path for electrons to flow to a cathode of each MEA. Each of first fuel cell 8150, second fuel cell 8250, third fuel cell 8350, and fourth fuel cell 8450 is illustrated as a single cell coupled to respective electrical terminals. In exemplary embodiments, electrical potential differences between first positive terminal connection 8100 and first negative terminal connection 8200, second positive terminal connection 8300 and second negative terminal connection 8400, third positive terminal connection 8500 and third negative terminal connection 8600, and fourth positive terminal connection 8700 and fourth negative terminal connection 8800 can be less than approximately 1.2 volts at open circuit. In certain exemplary embodiments, additional fuel cells can be place in series with one or more of first fuel cell 8150, second fuel cell 8250, third fuel cell 8350, and/or fourth fuel cell 8450. System 8000 can comprise a plurality of systems 4000 illustrated in FIG. 4.

FIG. 9 is a block diagram of an exemplary embodiment of a system 9000, which can comprise a plurality of systems 5000 illustrated in FIG. 5. System 9000 can comprise a plurality of fuel cell systems, which can comprise a first fuel cell system 9100, a second fuel cell system 9300, a third fuel cell system 9500, and a fourth fuel cell system 9700. Each of first fuel cell system 9100, second fuel cell system 9300, third fuel cell system 9500, and fourth fuel cell system 9700 can comprise a plurality of fuel cells coupled in series, such as five cells in series as illustrated in FIG. 9. A count of fuel cells in fuel cell systems such as first fuel cell system 9100 can be any count, such as 1, 2, 3, 4, 5, 8, 10, 14, 22, 100, and/or any other value, etc. Thus, each of first fuel cell system 9100, second fuel cell system 9300, third fuel cell system 9500, and fourth fuel cell system 9700 can, in exemplary embodiments, can comprise an electrical potential difference between positive and negative terminals of an electrical potential difference associated with a single fuel cell multiplied by a fuel cell system cell count. The electrical potential difference associated with a single fuel cell can be any voltage value, determinable by fuel cell efficiency, which is less than a theoretical voltage associated with an electrochemical reaction between hydrogen and oxygen that is approximately 1.2 volts at open circuit. Certain exemplary embodiments can comprise dividing barriers adapted to prevent shorting between fuel cells due to water produced in fuel cell reactions.

System 9000 can comprise a plurality of channels adapted to direct a flow of oxygen, such as a first oxygen channel 9150, a second oxygen channel 9350, and a third oxygen channel 9550. Oxygen can be introduced from a first oxygen supply 9050, a second oxygen supply 9400, and a third oxygen supply 9800 to, respectively, first oxygen channel 9150, second oxygen channel 9350, and third oxygen channel 9550.

System 9000 can comprise a plurality of channels adapted to direct a flow of hydrogen, such as a first hydrogen channel 9250, and a second hydrogen channel 9450. Hydrogen can be introduced from a first hydrogen supply 9200 and a second hydrogen supply 9600 to, respectively, first hydrogen channel 9250, and second hydrogen channel 9450.

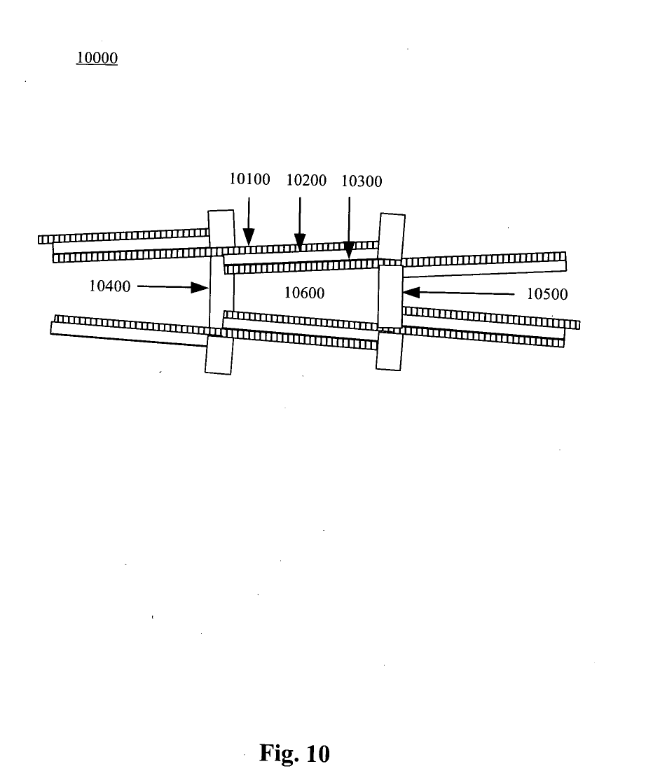

FIG. 10 is a block diagram of an exemplary embodiment of a system 10000, which can comprise a fuel cell. The fuel cell can comprise a first gas permeable electrically conductive layer 10100, a MEA 10200, and a second gas permeable electrically conductive layer 10300. A channel 10600 can be defined and/or used by the fuel cell of system 10000 to direct a flow of hydrogen, oxygen, liquid water, and/or water vapor. Channel 10600 can be partially defined by a first seal strip 10400 and/or a second seal strip 10500. Channel 10600 can comprise a square, rectangular, trapezoidal, and/or irregular cross section. First seal strip 10400 and/or second seal strip 10500 can be adapted to prevent liquid water and/or water vapor from shorting across one or more fuel cells. In certain exemplary embodiments, cathodes can be susceptible to developing short circuits due to water. First seal strip 10400 and/or second seal strip 10500 can comprise beads of sealants, gasket-like strips, rigid separator strips, and/or tubes adapted to convey coolant for thermal management, etc. First seal strip 10400 and/or second seal strip 10500 can be permeable to hydrogen and/or oxygen. First seal strip 10400 and/or second seal strip 10500 can be electrically conductive in all or part of first seal strip 10400 and/or second seal strip 10500. In certain exemplary embodiments, channel 10600 can be filled with a solid, air permeable material adapted to form a support layer for the fuel cell and/or components coupled thereto.

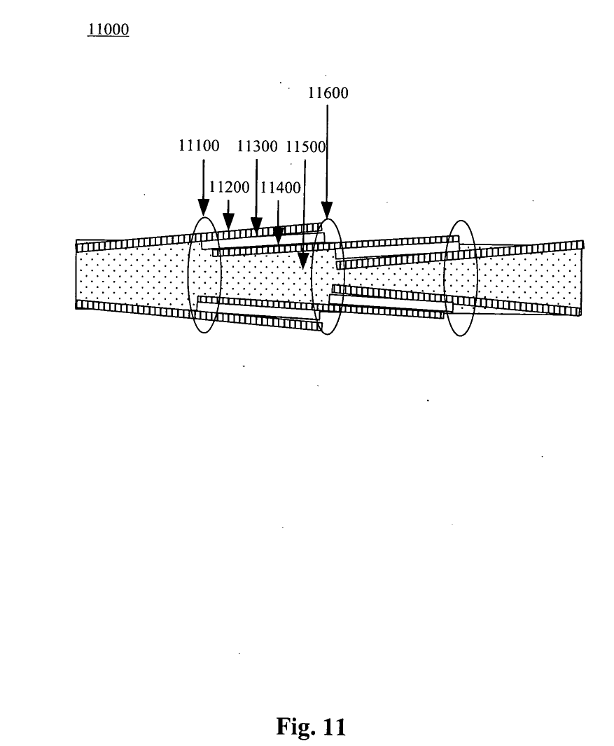

FIG. 11 is a block diagram of an exemplary embodiment of a system 11000, which can comprise a fuel cell comprising a first gas permeable electrically conductive layer 11200, a MEA 11300, and a second gas permeable electrically conductive layer 11400. A channel 11500 can be defined and used by the fuel cell of system 11000 to direct a flow of hydrogen, oxygen, liquid water, and/or water vapor. Channel 11500 can be defined and/or supported by a solid water and/or gas permeable material adapted to form a support layer for the fuel cell and/or components coupled thereto. The fuel cell can be sealed from adjacent fuel cells by water-tight seals such as a first water-tight seal 11100 and/or a second water-tight seal 11600. First water-tight seal 11100 and/or second water-tight seal 11600 can be formed by infusing a polymeric adhesive or sealant into respective sections of first gas permeable electrically conductive layer 11200 and second gas permeable electrically conductive layer 11400.

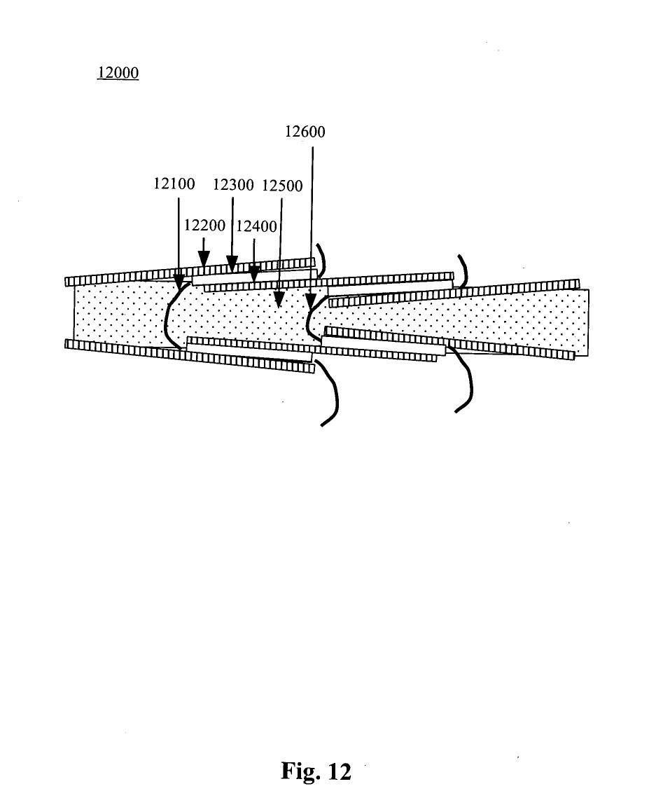

FIG. 12 is a block diagram of an exemplary embodiment of a system 12000, which can comprise a fuel cell comprising a first gas permeable electrically conductive layer 12200, a MEA 12300, and a second gas permeable electrically conductive layer 12400. A channel 12500 can be defined and used by the fuel cell of system 12000 to direct a flow of hydrogen, oxygen, liquid water, and/or water vapor. Channel 12500 can be defined and/or supported by a solid, air permeable material adapted to form a support layer for the fuel cell and/or components coupled thereto. The fuel cell can be sealed from adjacent fuel cells by membranes such as a first membrane 12100 and/or a second membrane 12600. First membrane 12100 and/or second membrane 12600 can be adapted to prevent water from shorting one or more of a plurality of fuel cells comprised in system 12000. In certain exemplary embodiments, first membrane 12100 and/or second membrane 12600 can be PEMs and/or less expensive membranes bonded, sealed, and/or attached to PEMs.

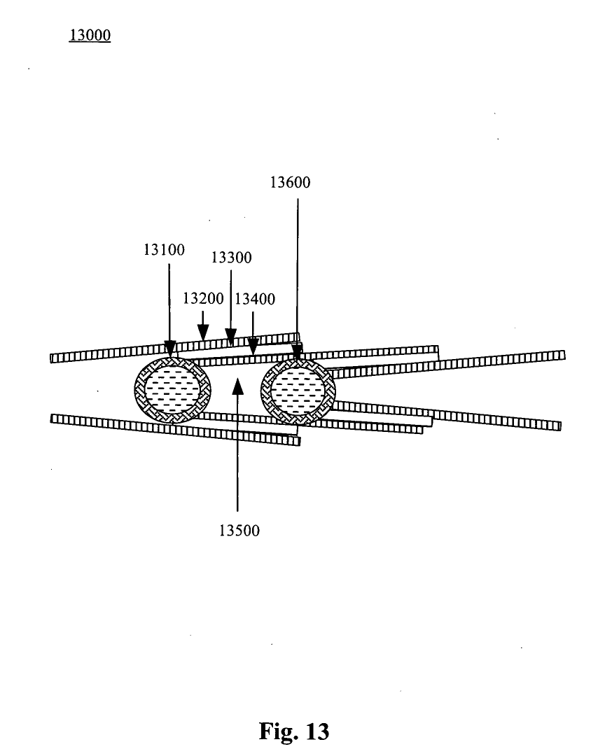

FIG. 13 is a block diagram of an exemplary embodiment of a system 13000, which can comprise a fuel cell comprising a first gas permeable electrically conductive layer 13200, a MEA 13300, and a second gas permeable electrically conductive layer 13400. A channel 13500 can be defined and used by the fuel cell of system 13000 to direct a flow of hydrogen, oxygen, liquid water, and/or water vapor. Channel 13500 can be empty and/or defined and/or supported by a solid, air permeable material adapted to form a support layer for the fuel cell and/or components coupled thereto. The fuel cell can be sealed from adjacent fuel cells by membranes such as a first tube 13100 and/or a second tube 13600. First tube 13100 and/or second tube 13600 can comprise a cross section that is circular, square, rectangular, trapezoidal, and/or any other shape. First tube 13100 and/or second tube 13600 can be adapted to direct a flow of coolant to one or more fuel cells comprised in system 13000 for thermal management thereof. In certain exemplary embodiments, additional coolant channels can be sandwiched, layered, or alternated with reactant gas channels to control temperatures within and/or related to system 13000.

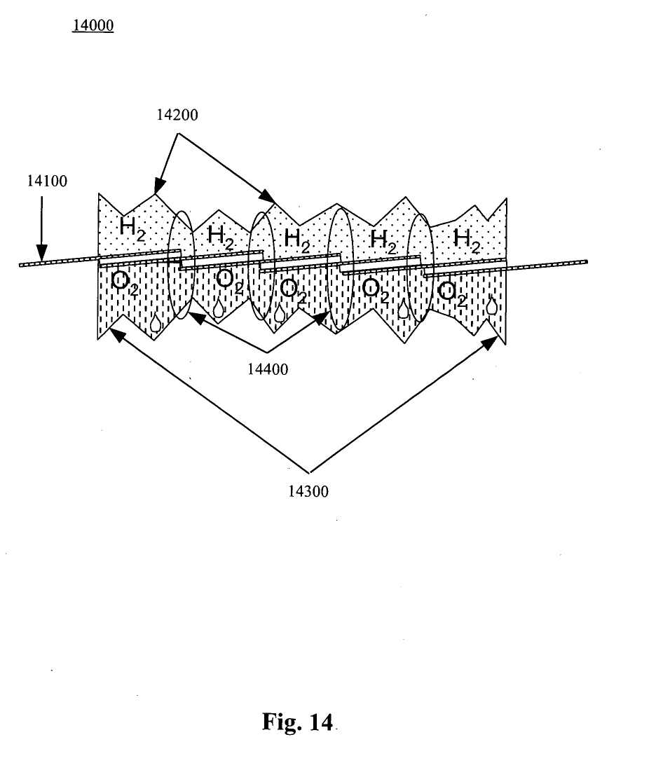

FIG. 14 is a block diagram of an exemplary embodiment of a system 14000, which can comprise a plurality of fuel cells 14100 electrically coupled in series. System 14000 can comprise a first set of gas channels 14200 adapted to direct a flow of hydrogen to plurality of fuel cells 14100. System 14000 can comprise a second set of gas channels 14300 adapted to direct a flow of oxygen to plurality of fuel cells 14100. Each of plurality of fuel cells 14100 can be separated by a set of separator strips 14400. Plurality of separator strips 14400 can be adapted to be gas-tight and/or prevent water from shorting one or more of plurality of fuel cells 14100. In certain exemplary embodiments, separator strips 14400 can be PEMs and/or less expensive membranes bonded, sealed, and/or attached to PEMs. Separator strips 14400 can be a Gore-Tex material, available from Gore Corporation of Elkton, Md. Separator strips 14400 can comprise a gasket, seals, sealants, adhesives, caulks, and/or other materials. In certain exemplary embodiments, separator strips 14400 can be installed only on the cathode side of plurality of fuel cells 14100. First set of gas channels 14200 and/or second set of gas channels 14300 can be open and/or can comprise a porous or electrically insulating corrugated polymer support layer media through which gases and liquid water can pass. In certain exemplary embodiments, separator strips 14400 can comprise channels adapted to be used for coolant flow to cool plurality of fuel cells 14100. Water produced by plurality of fuel cells 14100 can be directed away from plurality of fuel cells 14100 via second set of gas channels 14300.

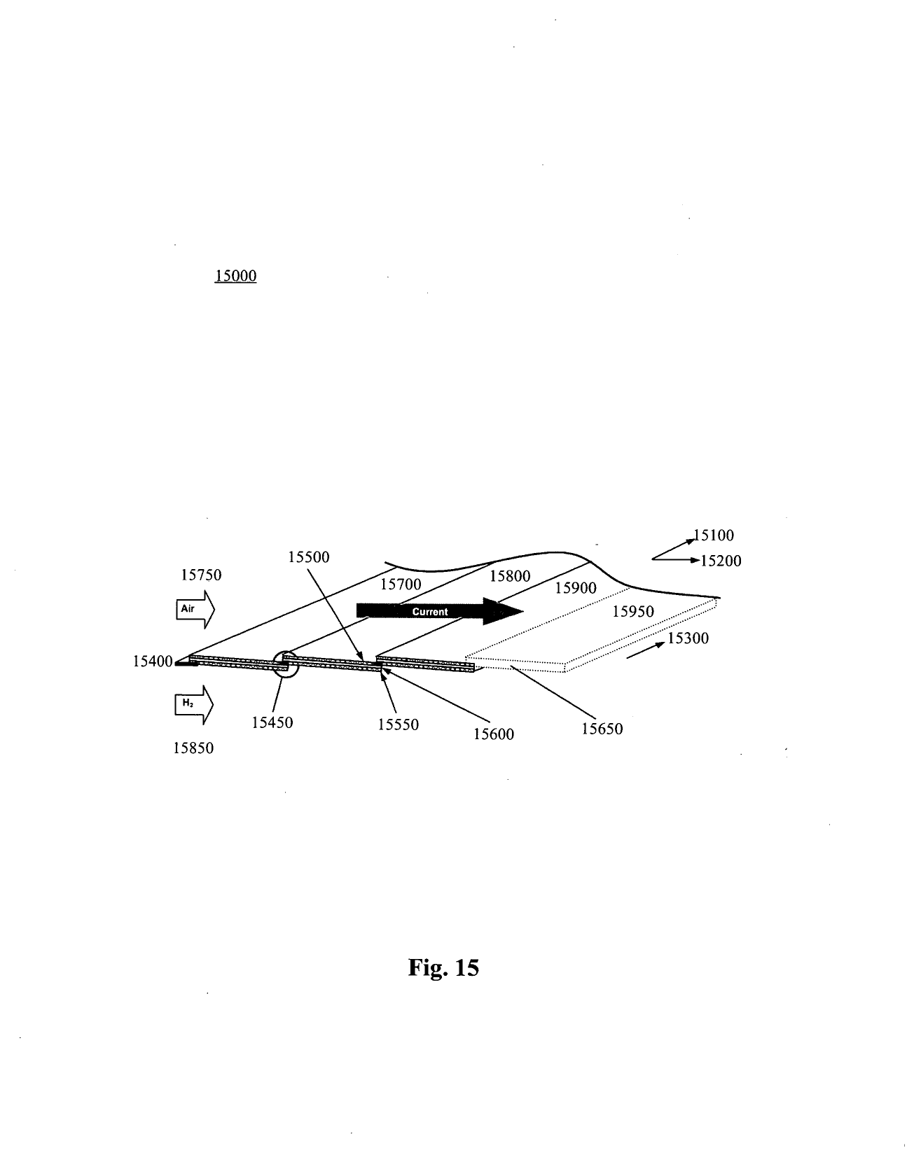

FIG. 15 is a block diagram of an exemplary embodiment of a system 15000, which can comprise a plurality of fuel cells coupled in series. A count of fuel cells coupled in series in system 15000 can be determined based upon a desired output voltage for system 15000. System 15000 can define a longitudinal direction 15100 and a latitudinal direction 15200. A length 15300 can be associated with a magnitude of an electrical current generated by each fuel cell in system 15000. A width 15650 can be associated with one or more fuel cells comprised in system 15000, such as fourth fuel cell 15950. System 15000 can comprise a first fuel cell 15700, a second fuel cell 15800, a third fuel cell 15900, and a fourth fuel cell 15950. An amount of current produced by fuel cells, such as first fuel cell 15700, second fuel cell 15800, third fuel cell 15900, and fourth fuel cell 15950 can be determined by length 15300 and widths, such as width 15650. An anode of fuel cell 15700 can be electrically coupled to a negative terminal 15400. A positive terminal (not illustrated) can be electrically coupled to a cathode of a last fuel cell (not illustrated) in system 15000. Fuel cell 15700 can be coupled to fuel cell 15800 via a gas-tight interface 15450. Gas tight interface 15450 can comprise an overlapped portion of a gas permeable electrically conductive layer associated with first fuel cell 15700 to an overlapped portion of a gas permeable electrically conductive layer associated with second fuel cell 15800 via an electrical adhesive.

Each fuel cell can comprise an anode gas permeable electrically conductive layer, such as anode gas permeable electrically conductive layer 15550 of fuel cell 15800. Each fuel cell can comprise a cathode gas permeable electrically conductive layer, such as cathode gas permeable electrically conductive layer 15500 of fuel cell 15800. Each fuel cell can comprise a MEA, such as MEA 15600 of fuel cell 15800. System 15000 can comprise an air supply 15750 to provide oxygen to first fuel cell 15700, second fuel cell 15800, third fuel cell 15900, and fourth fuel cell 15950. System 15000 can comprise a hydrogen supply 15850 to provide hydrogen to first fuel cell 15700, second fuel cell 15800, third fuel cell 15900, and fourth fuel cell 15950.

An architecture illustrated in system 15000 is presented for illustrative purposes and is not intended to be limiting. For example, system 15000 can incorporate any of the architectures of system 4000 of FIG. 4, system 5000 of FIG. 5, system 6000 of FIG. 6, and/or system 7000 of FIG. 7, etc. In certain exemplary embodiments, system 15000 can comprise any a seal system, such as seal system illustrated in system 8000 of FIG. 8, system 10000 of FIG. 10, system 11000 of FIG. 11, system 12000 of FIG. 12, and/or system 13000 of FIG. 13, etc. In certain exemplary embodiments, system 15000 can comprise any a support system such as a support system illustrated in system 14000 of FIG. 14.

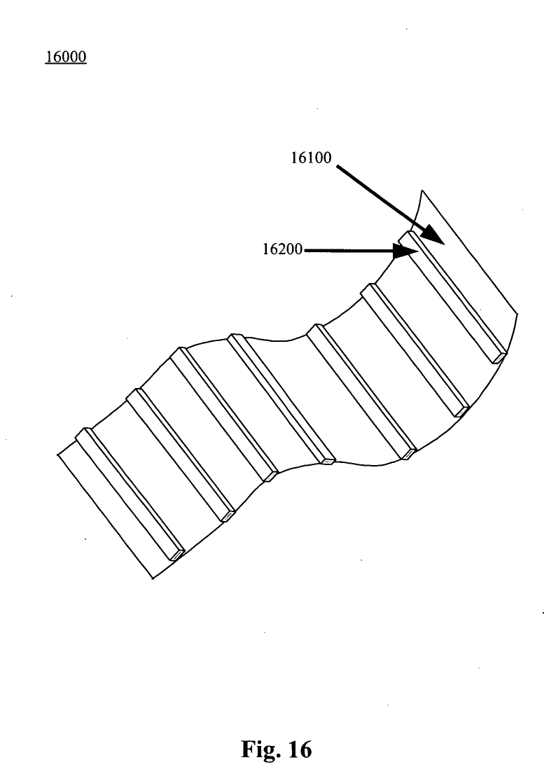

FIG. 16 is a perspective view of a diagram of an exemplary embodiment of a fuel cell sheet 16000, which can comprise one or more MEAs 16100 and one or more spacer strips 16200. System 16000 can comprise a plurality of subsystems from system 15000 of FIG. 15. System 16000 can be adapted for fabrication by a lamination method known to those skilled in the art.

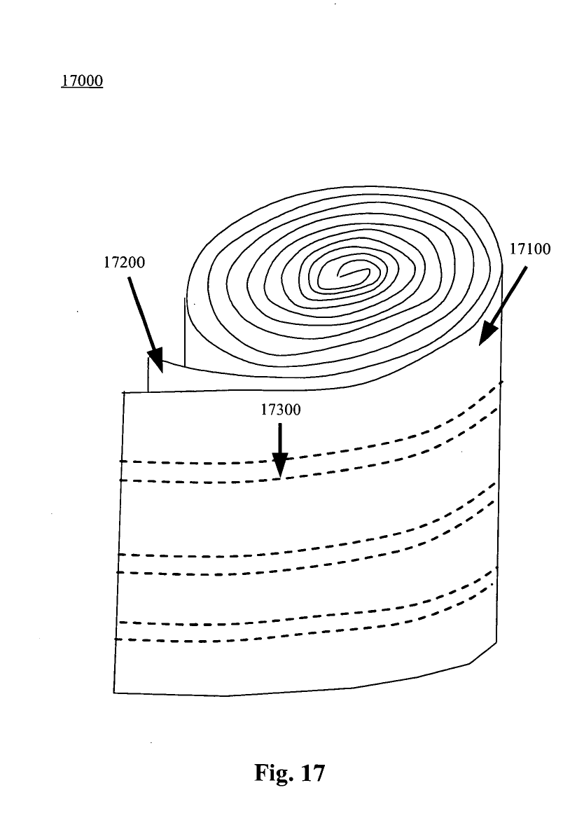

FIG. 17 is a perspective view of a diagram of an exemplary embodiment of a system 17000 comprising a fuel cell sheet, such as fuel cell sheet 16000 illustrated in FIG. 16. The fuel cell sheet can be rolled to form a coil. A sheet 17100 can comprise bonded spacer strips 17300. The coil can be bonded via an adhesive adapted to bond spacer strips 17300 to a surface 17200 of sheet 17100. Many varieties of coiled embodiments are possible, such as arrangements comprising pitches that are double, quadruple, and/or any other value pitch, etc. Spacer strips can be oriented circumferentially, axially, or helically. In certain exemplary embodiments, system 17000 can comprise a central flow tube adapted to direct a flow of hydrogen and/or oxygen. System 17000 might or might not comprise a porous insulating material and/or insulating corrugated material in the coil between MEA layers. Channels and/or spiral layers can be incorporated in system 17000 for coolant usable for thermal management. System 17000 can comprise any of a plurality of seals, spacers, and/or supports such as might be comprised in system 15000 of FIG. 15.

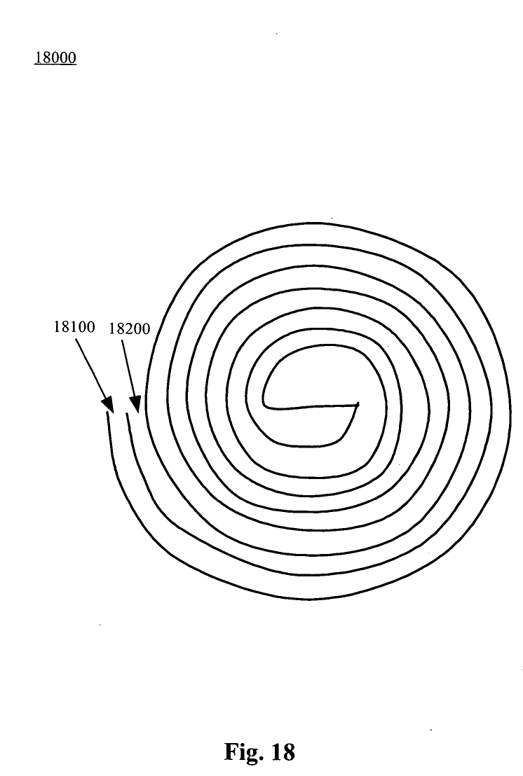

FIG. 18 is a plan view of a diagram of an exemplary embodiment of a system 18000 comprising a fuel cell sheet, such as fuel cell sheet 16000 illustrated in FIG. 16. System 18000 can define a first channel 18100 and a second channel 18200. First channel 18100 can be adapted to receive hydrogen from a hydrogen source. Second channel 18200 can adapted to receive oxygen from and oxygen source. Reactant gas inlets and/or outlets in exemplary systems can be at one or more outer edges of channels, one or more central tubes, distributed along one or both ends of a spiral coil, and/or any combination thereof, etc. Electrical connections to system 18000 can be made at outer edges, central terminals, one or both ends, and/or a combination thereof. System 18000 can comprise any of a plurality of seals, spacers, and/or supports such as might be comprised in system 15000 of FIG. 15.

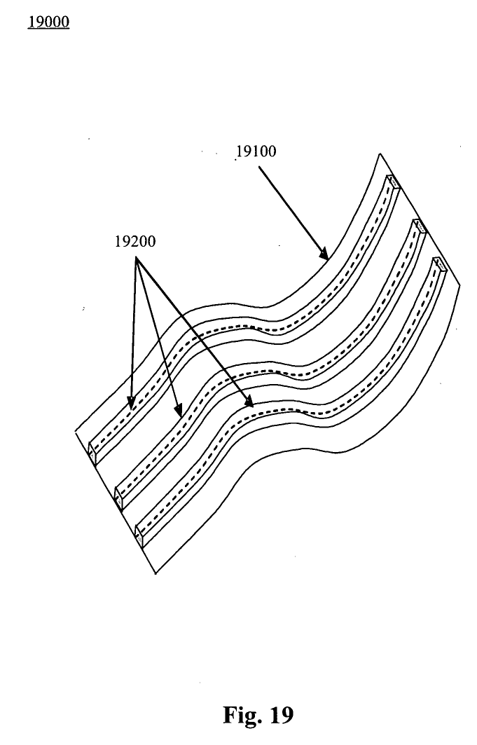

FIG. 19 is a perspective view of a diagram of an exemplary embodiment of a fuel cell sheet 19000, which can comprise one or more MEAs 19100 and a plurality of spacer strips 19200. System 19000 can comprise a plurality of subsystems from system 4000 of FIG. 4. System 19000 can comprise any of a plurality of seals, spacers, and/or supports such as might be comprised in system 15000 of FIG. 15.

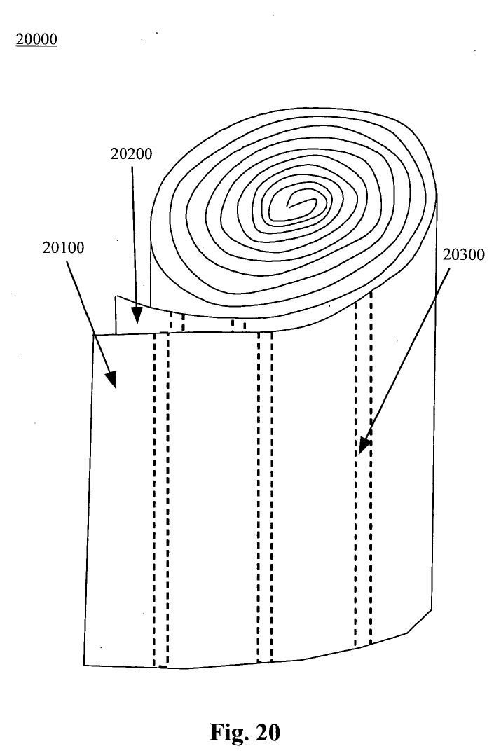

FIG. 20 is a perspective view of a diagram of an exemplary embodiment of a system 20000 comprising a fuel cell sheet comprising a fuel cell sheet, such as fuel cell sheet 19000 illustrated in FIG. 19. The fuel cell sheet can be rolled to form a coil. A sheet 20100 can comprise bonded spacer strips 20300. The coil can be bonded via an adhesive adapted to bond spacer strips 20300 to a face 20200 of sheet 20100. Thus, system 20000 can comprise a plurality of parallel and/or non-parallel non-planar gas permeable electrically conductive layers, such as gas permeable electrically conductive layers comprised in sheet 20100. System 20000 can comprise any of a plurality of seals, spacers, and/or supports such as might be comprised in system 15000 of FIG. 15.

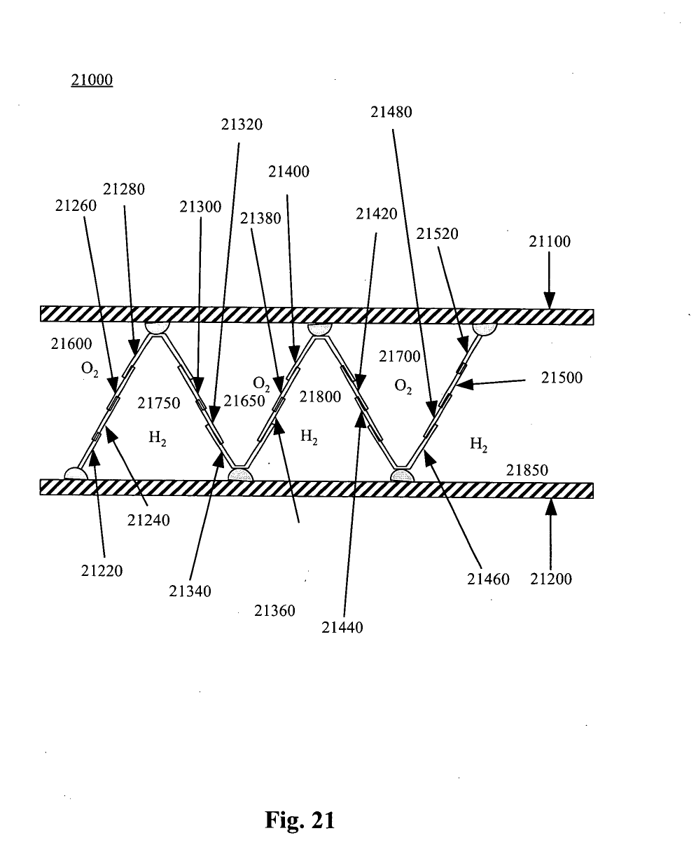

FIG. 21 is a plan view of a diagram of an exemplary embodiment of a system 21000, which can comprise a first electrical terminal 21100 and a second electrical terminal 21200. System 21000 can comprise a plurality of channels adapted to direct a flow of hydrogen, oxygen, liquid water, and/or water vapor. For example, system 21000 can comprise a first oxygen channel 21600, a second oxygen channel 21650, a third oxygen channel 21700, a first hydrogen channel 21750, a second hydrogen channel 21800, and a third hydrogen channel 21850. System 21000 can comprise a first subset of MEAs 21220, 21240, 21260, and 21280. System 21000 can comprise a second subset of MEAs 21280, 21300, 21320, and 21340. System 21000 can comprise a third subset of MEAs 21340, 21360, 21380, and 21400. System 21000 can comprise a fourth subset of MEAs 21400, 21420, 21440, and 21460. System 21000 can comprise a fifth subset of MEAs 21460, 21480, 21500, and 21520. Each of the five subsets of MEAs can be arranged to provide four fuel cells each electrically coupled in series to first electrical terminal 21100 and second electrical terminal 21200.

System 21000 can comprise a first fuel cell, such as a fuel cell comprising MEA 21260 can be coupled in series with a second fuel cell, such as a fuel cell comprising MEA 21280. A first gas permeable electrically conductive layer of the second fuel cell might not be parallel with the first gas permeable electrically conductive layer of the first fuel cell. MEA 21280 can comprise a first portion of a first gas permeable electrically conductive layer that might not be parallel with a second portion of the first gas permeable electrically conductive layer

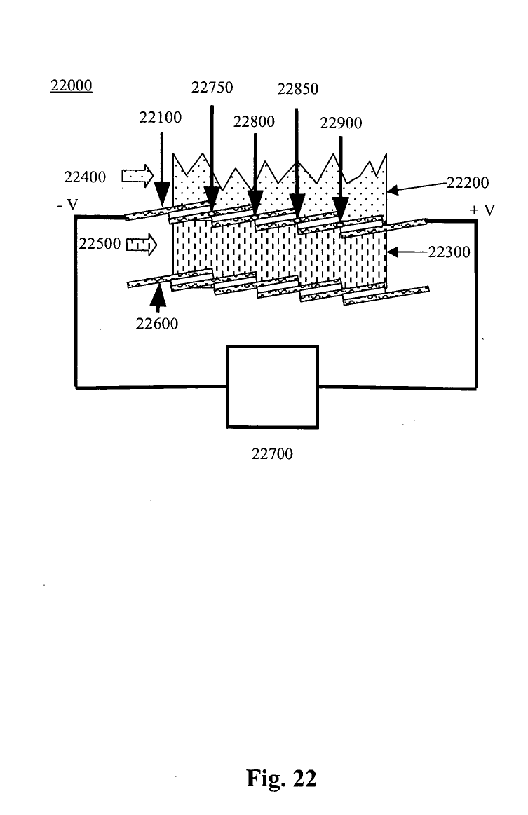

FIG. 22 is a plan view of a diagram of an exemplary embodiment of a system 22000, which can comprise a first plurality of MEAs 22100. First plurality of MEAs 22100 can be adapted to form a plurality of fuel cells. System 22000 can comprise a second plurality of MEAs 22600. System 22000 can comprise a first channel 22200 adapted to direct a flow of hydrogen. System 22000 can comprise a second channel 22300 adapted to direct a flow of oxygen. Hydrogen can be provided to first channel 22200 from a hydrogen source 22400. Oxygen can be provided to second channel 22300 from an oxygen source 22500. In exemplary embodiments, an electric current can be generated by first plurality of MEAs 22100. First plurality of MEAs 22100 can be electrically coupled to an electrical load 22700.

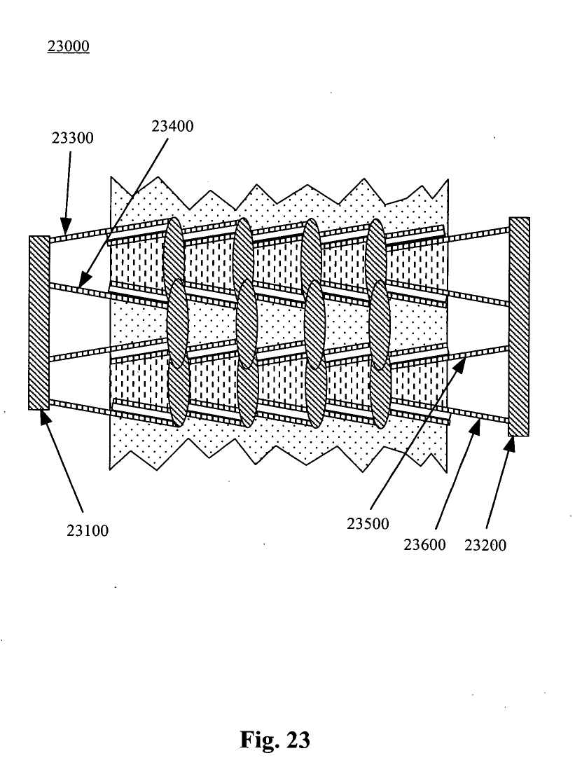

FIG. 23 is a block diagram of an exemplary embodiment of a system 23000, which can comprise a positive bus 23100 and a negative bus 23200. Positive bus 23100 and negative bus 23200 can be comprised in a circuit comprising an electrical load (not shown). A plurality of sets of fuel cells can be electrically coupled to positive bus 23100 and negative bus 23200. For example, a first set of fuel cells 23300, a second set of fuel cells 23400, a third set of fuel cells 23500, and a fourth set of fuel cells 23600 can be electrically coupled to positive bus 23100 and negative bus 23200 in a parallel electrical coupling. Fuel cells electrically coupled in series, such as each of first set of fuel cells 23300, second set of fuel cells 23400, third set of fuel cells 23500, and fourth set of fuel cells 23600 can each generate a voltage of approximately a count of fuel cells coupled in series multiplied by a voltage produced by a single fuel cell. Hydrogen and/or oxygen supplied to each of first set of fuel cells 23300, second set of fuel cells 23400, third set of fuel cells 23500, and fourth set of fuel cells 23600 in a flow pattern substantially parallel to a given set of fuel cells, counterflow, cross-flow, and/or any other flow pattern. Each of first set of fuel cells 23300, second set of fuel cells 23400, third set of fuel cells 23500, and fourth set of fuel cells 23600 can generate an additive electrical current deliverable to positive bus 23100. A count of fuel cell sets can be determined based upon a desired current output from system 23000.

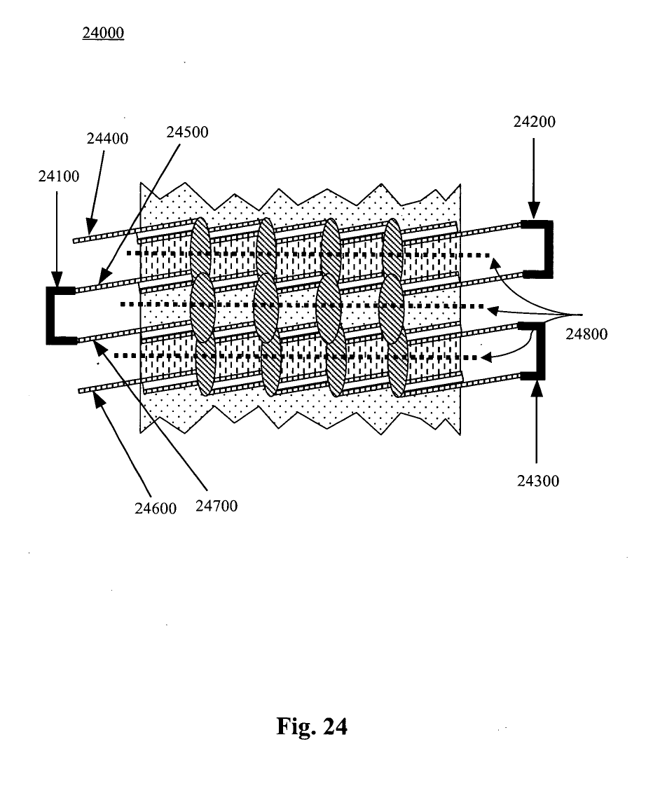

FIG. 24 is a block diagram of an exemplary embodiment of a system 24000, which can comprise a first bus 24100, a second bus 24200, and a third bus 24300. A plurality of sets of fuel cells can be electrically coupled to first bus 24100, second bus 24200, and third bus 24300. For example, a first set of fuel cells 24400, a second set of fuel cells 24500, a third set of fuel cells 24600, and a fourth set of fuel cells 24700 can be electrically coupled to first bus 24100, second bus 24200, and third bus 24300 in a series electrical coupling. Twenty fuel cells electrically coupled in series, such as each of first set of fuel cells 24400, second set of fuel cells 24500, third set of fuel cells 24600, and fourth set of fuel cells 24700 can each generate a voltage approximately equal to a voltage produced by a single cell multiplied by a count of cells in a circuit (such as the 20 cells illustrated in system 24000). First set of fuel cells 24400 and third set of fuel cells 24600 can be electrically coupled to an electrical circuit comprising an electrical load (not shown). Hydrogen and/or oxygen supplied to each of first set of fuel cells 24400, second set of fuel cells 24500, third set of fuel cells 24600, and fourth set of fuel cells 24700 in a flow pattern substantially parallel to a given set of fuel cells, counterflow, cross-flow, and/or any other flow pattern. Each of first set of fuel cells 24400, second set of fuel cells 24500, third set of fuel cells 24600, and fourth set of fuel cells 24700 can generate an additive electrical voltage deliverable to the electrical circuit. A count of fuel cell sets can be determined based upon a desired voltage output from system 24000. A total area of first set of fuel cells 24400, second set of fuel cells 24500, third set of fuel cells 24600, and fourth set of fuel cells 24700 can determine a total current output of system 24000. System 24000 can comprise a plurality of membranes 24800 adapted to prevent water produced from each of first set of fuel cells 24400, second set of fuel cells 24500, third set of fuel cells 24600, and fourth set of fuel cells 24700 from shorting between one or more of first set of fuel cells 24400, second set of fuel cells 24500, third set of fuel cells 24600, and fourth set of fuel cells 24700.

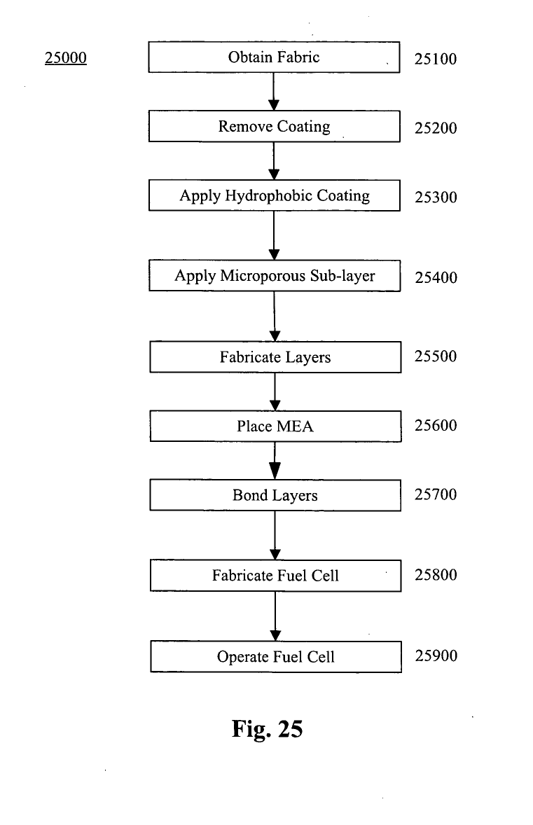

FIG. 25 is a flowchart of an exemplary embodiment of a method 25000, which can comprise a plurality of activities. At activity 25100, a fabric can be obtained. In certain exemplary embodiments, the fabric can be a PAN fiber fabric, such as a PAN fiber fabric obtained from ETEK, Inc. In certain exemplary embodiments, the fabric can be a woven fabric comprising pitch fibers such a Mitsubishi-3HS fabric. The fabric can comprise extruded, drawn, and/or spun fibers. The fabric can be woven with a satin weave. The fabric can be a 1-harness, 2-harness, 3-harness, 4-harness, or 5-harness fabric comprised of bundles that comprise approximately 200 to approximately 5000 fibers. The fabric can be obtained with a coating and/or sizing, such as an epoxy coating and/or sizing. Fibers comprised in the fabric can be greater in length than approximately one millimeter. Fibers comprised in the fabric might not be vapor grown, might not be extruded, and/or might not be stretch broken.

At activity 25200, a coating and/or sizing can be removed from the fabric. The fabric can be heated to remove the coating and/or sizing. The fabric can be heated to a temperature above approximately a temperature, in degrees centigrade, of 100, 120.1, 189.5, 214, 248.9, 335.7, 289, 400, 440.1, 600, and/or any value or sub-range therebetween. The fabric can be heated for a time, in minutes, of approximately 0.05, 0.1, 0.24, 0.8, 1, 5.8, 10, 14.7, 24.9, 30, 46.6, 87, 98.1, 678, 1500, and/or any value or sub-range therebetween.

At activity 25300, a hydrophobic coating can be applied to the fabric. For example, the hydrophobic coating can comprise PTFE, polychlorotrifluoroethylene, perfluoroalkoxy, fluorinatedethylenepropylene, ethylenetetrafluoroethylene, and/or any other polymer, etc. For example, the fabric can be soaked in a dispersion comprising the hydrophobic coating. The fabric can be dried after applying the hydrophobic coating in one or more stages. Each of the one or more stages can comprise drying the fabric at a temperature above approximately a temperature, in degrees centigrade, of 100, 122.5, 147.8, 221, 267, 334.1, 289.8, 400, 440, 600, and/or any value or sub-range therebetween. The fabric can be heated for a time, in minutes, of approximately 0.05, 0.2, 0.29, 0.66, 1, 3.7, 10.8, 15, 27, 31.2, 49, 77.7, 98.6, 500, 999.1, 1500, and/or any value or sub-range therebetween

At activity 25400, a microporous sub-layer can be applied to the fabric. The microporous sub-layer can be applied in a thickness greater, in microns, than approximately 1, 5, 6, 9.2, 11.2, 14, 15, 18.0, 24.7, 55.4, 87.2, 99, 125, 250, and/or any other value or sub-range therebetween. The microporous sub-layer can be applied via airbrushing a mixture of components on the fabric. The mixture of components can comprise a polymer such as PTFE, polychlorotrifluoroethylene, perfluoroalkoxy, fluorinatedethylenepropylene, ethylenetetrafluoroethylene, and/or any other polymer, etc. The mixture can comprise carbon particles and an alcoholic liquid carrier such as methanol, ethanol, propanol, and/or 2-propanol, etc. The microporous sub-layer can be applied on a side of the fabric that is adapted to be adjacent to a catalyst layer adapted for use in a fuel cell. After applying the mixture of components on the fabric, the fabric can be sintered at a temperature greater than, in degrees centigrade, approximately 200, 227.6, 250, 289.3, 327, 335.9, 354.3, 400, and/or any other value or sub-range therebetween.

At activity 25500, a gas permeable electrically conductive layer can be fabricated. The gas permeable electrically conductive layer can comprise a piece of the fabric treated via activities such as activity 25200, activity 25300, and/or activity 25400, etc. The gas permeable layer can comprise an in-plane resistivity of less than 0.2 ohms/square and a through plane resistance of less than 0.02 ohm-square centimeters when compressed at 500 kilopascals and an uncompressed Darcy permeability greater than 20 Darcys. When adapted for use as an in-plane current collector in a fuel cell, the combination of a membrane electrode assembly and two gas permeable electrically conductive layers can be adapted to yield a fuel cell current density of greater than approximately 0.1 amps per square centimeter when approximately 0.5 volts is applied to a fuel cell width of approximately three centimeters.

At activity 25600, a MEA can be placed. The MEA can be purchased from a supplier such as Gore of Elkton, Md. or Ion Power of New Castle, Del. The MEA can be placed adjacent to a first gas permeable electrically conductive layer. The MEA can be sandwiched between the first gas permeable electrically conductive layer and a second gas permeable electrically conductive layer.

At activity 25700, the first gas permeable electrically conductive layer can be bonded to the second gas permeable electrically conductive layer via any technique such as hot pressing and/or an electrically conductive adhesive, etc. For example, a portion of the first gas permeable electrically conductive layer can be bonded to a portion of the second gas permeable electrically conductive layer. The portion of the second gas permeable electrically conductive layer can overlap the portion of the first distribution layer. The first gas permeable electrically conductive layer and the second gas permeable electrically conductive layer can be adapted to hydrogen, oxygen, liquid water, and/or water vapor.

At activity 25800, a fuel cell can be fabricated.

At activity 25900, the fuel cell can be operated to generate a direct current, which can be used to provide power to one or more electrical circuits and/or devices.

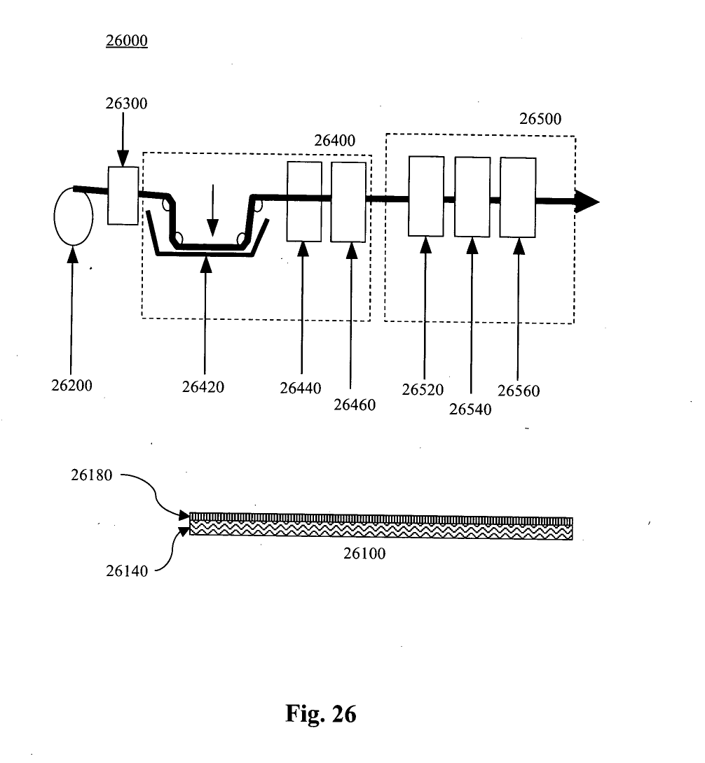

FIG. 26 is a block diagram of an exemplary embodiment of a system 26000, which can comprise a gas permeable electrically conductive layer 26100. Gas permeable electrically conductive layer 26100 can comprise a hydrophobic gas permeable electrically conductive layer 26140 and a MSL 26180. Gas permeable electrically conductive layer 26100 can be produced from a roll of untreated gas permeable electrically conductive layer material 26200. Roll of untreated gas permeable electrically conductive layer material 26200 can be heated in an oven 26300 to remove a coating and or sizing that might have been applied to roll of untreated gas permeable electrically conductive layer material 26200.

Roll of untreated gas permeable electrically conductive layer material 26200 can continue to a hydrophobic process 26400. First process 26400 can comprise a hydrophobic treatment bath 26420. Roll of untreated gas permeable electrically conductive layer material 26200 can proceed from hydrophobic treatment bath 26420 to a drying oven 26440. In certain exemplary embodiments, first process 26400 can comprise a sintering oven 26460.

Hydrophobic gas permeable layer 26140 can result from roll of untreated gas permeable electrically conductive layer material 26200 passing through first process 26400. Hydrophobic gas permeable layer 26140 can enter a second process 26500, which can comprise a MSL application process 26520. MSL application process 26520 can utilize one or more of spraying, airbrushing, tape casting, and/or any other MSL application method. Second process 26500 can comprise a drying oven 26540 and/or a sintering oven 26560, which can be adapted to complete preparation of gas permeable electrically conductive layer 26100.

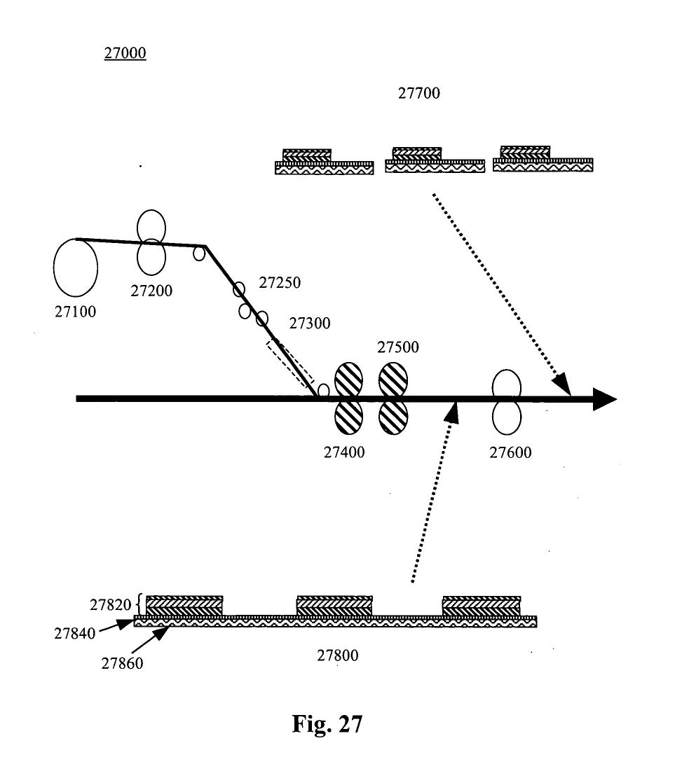

FIG. 27 is a block diagram of an exemplary embodiment of a system 27000, which can be adapted to produce cell ribbon segments 27700. System 27000 can be adapted to receive the gas permeable electrically conductive layer produced by system 26000 of FIG. 26. Cell ribbon segments 27700 can comprise an MEA and one or more gas permeable electrically conductive layers. System 27000 can comprise a roll of MEA 27100, which can be adapted to pass through slitting rolls 27200. System 27000 can comprise one or more turning and aligning rollers 27250, which can be adapted to space out MEA ribbons and register the MEA ribbons for bonding to one or more gas permeable electrically conductive layers. System 27000 can comprise a preheater 27300, which can prepare MEA ribbons for bonding to the one or more gas permeable electrically conductive layers. System 27000 can comprise a first set of heated nip rollers 27400 and/or a second set of heated nip rollers 27500 that can be adapted to bond MEA ribbons to the one or more gas permeable electrically conductive layers. A continuous ribbon 27800 can be produced from system 27000 after processing by first set of heated nip rollers 27400 and/or a second set of heated nip rollers 27500. Continuous ribbon 27800 can comprise MEA sections 27820 and a gas permeable electrically conductive layer comprising a hydrophobic layer 27860 and a MSL 27840. Continuous ribbon 27800 can pass through slitting rolls 27600 to produce cell ribbon segments 27700.

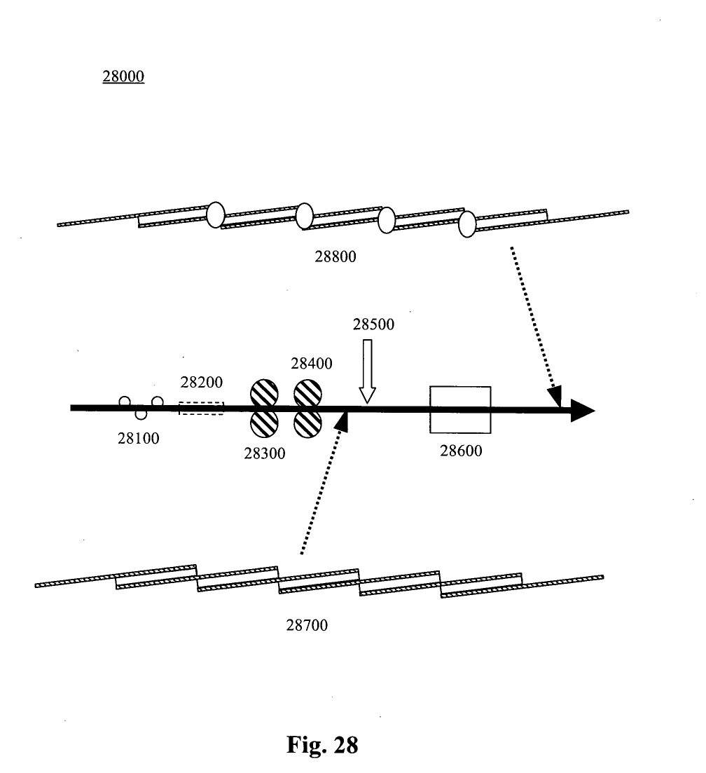

FIG. 28 is a block diagram of an exemplary embodiment of a system 28000, which can be adapted to produce a fuel cell subsystem 28800. System 28000 can be adapted to receive ribbon segments produced from system 27000 of FIG. 27 comprise one or more turning and aligning rollers 28100, which can be adapted to overlap ribbons and register the ribbons for bonding. System 28000 can comprise a preheater 28200 adapted to increase a temperature of the ribbons. System 28000 can comprise a first set of heated nip rollers 28300 and/or a second set of heated nip rollers 28400, which can be adapted to bond overlapped ribbons to form a set of laminated ribbon segments 28700. Set of laminated ribbon segments 28700 can be further prepared for use in fuel cell applications by adding gas and/or water impermeable beads via seal bead infuser 28500. System 28000 can comprise a curing oven adapted to cure the gas and/or water impermeable beads to produce fuel cell subsystem 28800.

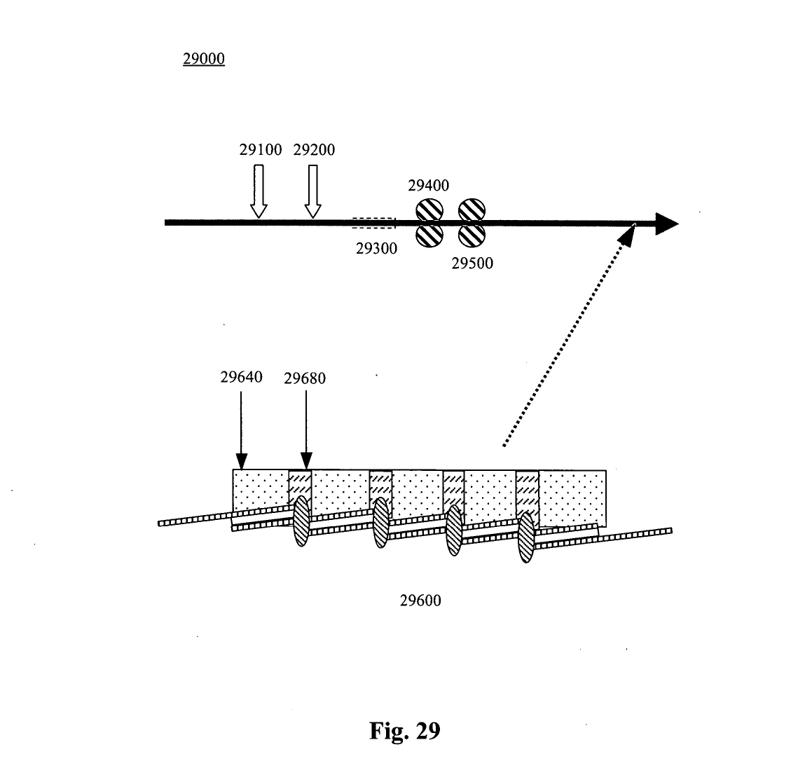

FIG. 29 is a block diagram of an exemplary embodiment of a system 29000, which can be adapted to produce supported fuel cell subsystem 29600. System 29000 can be adapted to receive fuel cell subsystem 28800 produced by system 28000 of FIG. 28. Supported fuel cell subsystem 29600 can comprise a porous and/or corrugated support layer 29640 and/or a plurality of seal strips 29680. System 29000 can comprise a strip applier 29100 and/or a support layer applyer 29200. System 29000 can comprise a preheater 29300, which can be adapted to prepare the assembly exiting strip applier 29100 and/or support layer applyer 29200 for bonding. System 29000 can comprise a first set of heated nip rolls 29400 and/or a second set of heated nip rolls 29500, which can be adapted to bond porous and/or corrugated support layer 29640 and/or seal strips 29680 to fuel cell subsystem 29600 to produce supported fuel cell subsystem 29600.

Still other practical and useful embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application.

Thus, regardless of the content of any portion (e.g., title, field, background, summary, abstract, drawing figure, etc.) of this application, unless clearly specified to the contrary, such as via an explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, performed by multiple entities, and/or performed in multiple jurisdictions; and
any activity or element can be specifically excluded, the sequence of activities can vary, and/or the interrelationship of elements can vary.

Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A method comprising:
assembling a first fuel cell comprising:
a first gas permeable electrically conductive layer; and
a second gas permeable electrically conductive layer, said second gas permeable electrically conductive layer substantially parallel to said first gas permeable electrically conductive layer, said first gas permeable electrically conductive layer separated from said second gas permeable electrically conductive layer by a first membrane electrode assembly, said first gas permeable electrically conductive layer bonded to an anode of said first membrane electrode assembly, said second gas permeable electrically conductive layer bonded to a cathode of said first membrane electrode assembly, said first membrane electrode assembly defining a first centroidal axis perpendicular to a planar surface of said first membrane electrode assembly, said second gas permeable electrically conductive layer adapted for use as an in-plane current collector in a fuel cell, the combination of said first membrane electrode assembly, said first gas permeable electrically conductive layer, and said second gas permeable electrically conductive layer adapted to yield a fuel cell current density of at least 0.25 amps per square centimeter of said membrane electrode assembly when a voltage differential between one end of an anode gas distribution layer and an opposite end of a cathode gas distribution layer is approximately 0.5 volts when said ends are separated by a width of approximately three centimeters;
assembling a second fuel cell comprising:
an anode comprised in a second membrane electrode assembly electrically coupled directly to said second gas permeable electrically conductive layer, said second membrane electrode assembly defining a second centroidal axis perpendicular to a planar surface of said anode comprised in said second membrane electrode assembly, said first centroidal axis substantially non-collinear with, said second centroidal axis; and
forming a gas-tight seal between said first fuel cell and said second fuel cell;
wherein said second gas permeable electrically conductive layer comprises a tab adapted to be bonded to a third gas permeable electrically conductive layer, said third gas permeable electrically conductive layer adapted to be bonded to said anode comprised in said second membrane electrode assembly, said tab at least partially forming said gas-tight seal between said first fuel cell and said second fuel cell, said gas-tight seal at least partially defining a channel adapted to direct a flow of a coolant for said first fuel cell.
